(19) United States
(12) Patent Application Publication
(10) Pub. No.: US 2025/0251260 A1
(43) Pub. Date: Aug. 7, 2025

(54) Modular Multi-Configurable Instrument Enclosures

(71) Applicant: Terrapin Industrial LLC, Houston, TX (US)

(72) Inventors: Brad Faseler, Houston, TX (US); Daniel Tagtow, Austin, TX (US); Matthew Nance, Boling, TX (US); James E. Bundschuh, Fenton, MO (US)

(73) Assignee: Terrapin Industrial LLC, Houston, TX (US)

(21) Appl. No.: 19/047,138

(22) Filed: Feb. 6, 2025

Related U.S. Application Data
(60) Provisional application No. 63/550,252, filed on Feb. 6, 2024.

(51) Int. Cl. G01D 11/24; G01D 11/30

(52) U.S. Cl. CPC G01D 11/245; G01D 11/30

(57) ABSTRACT

A modular and expandable multi-configurational instrument enclosure includes top and bottom sections, the bottom section having a first part and second part fastened to a third part, and hinges hinging the top and bottom sections to enable the top section to rotate between a closed positioned and an open position. When closed, the instrument enclosure defines an enclosed space suitable for receiving multiple field instruments. The bottom section may be fastened to an enclosure-supportive pipe stand or to a bracket fastened to the pipe stand. The bottom section provides openings configured to receive instrument-supportive pipe stands and/or an opening that receives process line tubing carrying process line signals to the field instruments. The field instruments can be affixed to an end portion of the instrument-supportive pipe stands received in the enclosed space and/or removably attached to an interior portion of the instrument enclosure.

### PRIORITY

This application is a nonprovisional conversion of and claims priority to U.S. Provisional Application 63/550,252 filed Feb. 6, 2024, entitled “Modular Multi-Configurable Instrument Enclosures”, the entirety of which is incorporated by reference herein.

### BACKGROUND

In fields of endeavor pertaining to petrochemical plants, refining facilities, upstream production of oil and gas, power plant generation, and other applicable fields, instruments are frequently employed in order to monitor or sense pressure, flow, temperature, and other process parameters. Frequently, such instruments are required and/or configured to operate in an outdoor environment, often in remote or otherwise isolated locations. These instruments may be referred to herein as “field instruments.” Instrument enclosures have been developed and used to protect instruments, including field instruments.

Conventional instrument enclosures include standard-sized rigid enclosures and customized, removable, soft cover enclosures. Conventional rigid enclosures are not generally suitable for enclosing field instruments that are directly attached to a pipe stand or the like. When a field instrument is to be enclosed with a conventional rigid enclosure, the field instrument is first affixed within the instrument enclosure and the overall enclosure, rather than the field instrument being attached directly to the pipe stand. Many mounting brackets may be required to arrange the instrument into what has been a rigid box-like structure in such a way that allows the instrument enclosure to be opened and closed.

Soft removable covers, often used in warmer climates to wrap around mounted instruments, tubing or tubing bundles, and power and communication wiring, are often closed using either metal rings or extended straps of fabric from the cover itself. These straps are typically equipped with a Velcro-like fastening arrangement. The metal rings may be used to run the strap through the ring and back to a matching Velcro section to secure the strap. To install a soft removable cover, one or more custom installers are generally required to go to a site, where the installer(s) may have to be escorted from instrument to instrument and build a custom template to accommodate the instrument body, the manifold to which it is mounted, any necessary apertures for both tubing or tubing bundle carrying the process fluid to the instrument, and any power or communication wiring. Due to this heretofore relatively high degree of customization and the need to reduce associated costs, these soft removable covers are often extremely difficult to re-install properly should they need to be removed for maintenance or any other reason. As a result, once they are removed from the instrument, these soft removable covers with one-off enclosure mechanisms are most frequently not re-installed at all, not re-installed correctly, or damaged, resulting in leaving the instrument exposed to ambient conditions.

In order for double and triple instrument sets or quantities to be mounted into a single enclosure, there is an additional set of complexities that require unique designs and associated engineering to ensure proper installation. The details needed to accomplish this task are not simple when manufacturing multi-instrument enclosure capable devices. Field installers find it difficult matching the engineered installation details with how and where the instrument is mounted, how and where the impulse tubing comes into the enclosure to provide a process stream to the instrument, and how and where any additional tubing for clearing and blowing down the instrument is to be located. This complexity lends itself to each and every multi-instrument requiring a multivariable configuration. Due to these unique installation requirements, these installations are normally tailored to fit the needs of the location in which they are installed. There has heretofore not been much ability to standardize the equipment and/or associated installation associated with one multi-instrument enclosure versus another. An inconsistent installation can be caused by several factors. Those factors become the surrounding “real estate” environment that includes any congestion of other equipment that surround the enclosure area. In addition, the installer of the enclosure may not take that congestion into consideration when the pipe stand is bolted to the structure where the multiple instruments are mounted. Additionally, another reason for the lack of standardization is that engineers creating the installation details in a professional building may have very little to no field experience. Engineers with little or no field experience do not understand what needs to be mounted in the space that has been chosen for the instruments located in the 3D model. What is modeled in 3D modelling software often does not exactly match the as-built configurations of a facility, in terms of the real estate in and around the enclosure. Due to the fact that the real estate/location is almost always congested, the field installation teams struggle to be able to mount multiple instruments into the enclosure in such a way that matches the installation details provided by engineering. This lack of experience and communication with field installations often has led to many extra hours of installation time determining how to best layout the instruments inside of the enclosure and route the tubing and power/control wiring to those instruments. The present disclosure addresses these needs and eliminates many of the concerns addressed above.

### SUMMARY

The instrument enclosure of the present disclosure provides clear and concise standardized mounting and assembly that provides a modular, expandable, and interchangeable instrument enclosure with the ability to be configured for a single set of instruments, double set of instruments or a triple set of instruments for installation applications. A complete system is provided that includes one or more pipe stands to and for an entry location as well as the power and control wiring for each instrument to a dedicated entry point, process tubing for both entry impulse lines feeding the instrument and blow down or vented tubing to an entry point. By providing this enclosure arrangement guess work is diminished for the field installation teams, who with current multi-instrument enclosures, have to cut each of the entry point apertures at their discretion either in the field, or in a shop environment before shipping to the field. Previously disclosed instrument enclosures that do have pipe stand entry apertures and conduit holes pre-set, are lacking the proper quantity of pipe stand apertures, and other entry apertures needed to mount multiple instruments into one enclosure in an offset position from center, which make it impossible to mount multiple instruments.

More specifically the present disclosure provides for one or more modular expandable multi-configurational instrument enclosures, comprising: a top section casing with a first, second, third, and fourth edge and bottom section casing with a first, second, third, and fourth edge, wherein the first edge of the bottom section casing is hinged and/or rotatably-affixed to the first edge of the top section casing via one or more hinges and wherein second, third, and fourth edges of the top casing section are in contact with or in immediate proximity to the second, third, and fourth edges of the bottom section casing that provides a housing that encloses at least a portion of the instrument enclosures such that one or more instruments within the enclosures is rotatable and wherein one or more hinges are configured to enable both the top section casing and the bottom section casing to rotate between a close positioned and one or more open position such that a bottom portion comprises two or more sections that includes both a bottom outer right side winged portion and a bottom outer left side winged portion such that when a center section is added between the bottom outer left side wing portion and the bottom outer right side wing portion so that joining both bottom portions creates a center section of the bottom portion that resides between the outer right side wing portion and the outer left side wing portion with two orifices for two pipe stands to allow for two pipe stands to enter into an annular space of the instrument enclosures in order that instruments that reside within the enclosure are also mountable to the two pipe stands and wherein the modular multi-configurable instrument enclosures include conduit/tube with pre-set engineered orifices configurations such that the instrument enclosures are also standardized to provide for complex multi-instrument, multi-tube applications that include impulse and blow down capabilities.

Here the one or more modular multi-configurational instrument enclosures of claim 1 wherein the two orifices between the center section and the left bottom winged portion and the center section and the right bottom winged portion allow for location of a tubing bundle bracket with pre-set orifices so that tubing bundles enter into the instrument enclosures such that tubing within the tubing bundles are easily plumbed to the instruments upon installation.

In at least one embodiment the one or more modular multi-configurational instrument enclosures of claim 1, wherein when the instrument enclosures require an expandable triple instrument enclosure, two center sections exist between an outer left winged portion and an outer right winged portion which creates three configured orifices between two center sections such that the two center sections reside between a left center portion and a left bottom winged portion and also between a right center section and a right bottom winged portion that includes three tubing bundle brackets with pre-set orifices so that three of more sets of tubing bundles can penetrate into the instrument enclosures so that tubing bundles are easily plumbed to the instruments upon installation.

In at least one embodiment the hinges between the top section casing and the bottom section casing along first edges of the top section casing and the bottom section casing includes additional hinging between top casing and bottom casing sections that provides multiple variations of open and closed configurations of the instrument enclosures wherein the additional hinging includes fixed and/or detachable hinging between any of second, third and fourth edges.

Here a first part of the bottom section casing possesses a first notch; a second part of the bottom section casing possesses a second notch; and wherein the first notch and the second notch are configured to define an opening in the bottom section casing.

In addition, the enclosures include a support bracket that provides compression against two or three pipe stands and supports the instrument enclosures so that multiple configurable and modular units are provided for in both double and triple enclosure configurations.

It is also important that enclosures also include pipe stand systems for vertical pipes to enter into the instrument enclosures that are maneuverable in that the pipe stand systems allow for pipes to be positioned in one or more prefabricated and mounted support brackets with openings that allow for single, double, and triple pipe stand configurations.

The conduit seals provide a separate housing portion attached to the enclosures via prefabricated bosses so that the bosses provide for screw and heating elements insertion while conduit seal housings are fixed to the instrument enclosures at precise locations where conduit penetration is required and wherein contained within the conduit housings are sealing mechanisms that include sealing compositions to seal penetrating conduits or tubing placed into the instrument enclosures.

In most cases there also exists an opening in the bottom section casing is configured to accept and connect with a pipe stand and wherein the pipe stand is attached to the bottom section casing and/or resides within an instrument enclosure.

In many instances one or more interior surfaces of the bottom section casing includes one or more instrument attachment elements that allow for attachment to, removal of, and/or rotation for a field instrument to the bottom section casing; and wherein the enclosed space exists to receive one or more field instruments removably attached to the bottom section casing.

Here it is also possible for an opening in the bottom section casing to be configured to receive one or more process line conduits that convey one or more measurable process parameters to the one or more field instruments.

In addition, one or more process line conduits are enclosed in-process line tubing; and the opening in said bottom section casing is configured to engage the process line tubing.

In a further embodiment a first portion of the bottom section casing defines a first pipe notch and a first line notch; and a second portion of the bottom section casing defines a second pipe notch and a second line notch such that the first pipe notch and the second pipe notch are configured to define a pipe stand opening in the bottom section casing such that the pipe stand opening is configured to engage the pipe stand; and wherein the first line notch and the second line notch are configured to define a process line opening in the bottom section casing;
wherein the process line opening is configured to receive process line tubing enclosing one or more process line signals conveying one or more process line parameters to the one or more field instruments.

Here the bottom section casing is configured to be fastened to bracket affixed to the pipe stand;
wherein the bracket includes a plurality of openings suitable for receiving fasteners; and wherein,
the bottom section casing includes a plurality of openings corresponding to the plurality of openings in the bracket.

In at least this embodiment the enclosures comprise a convex polyhedral instrument enclosure.

Here, the convex polyhedral instrument enclosures comprise a hexahedral instrument enclosure comprising six planar surfaces including an upper surface, a lower surface, a forward surface, a rearward surface, a left surface, and a right surface.

In addition, the top section casing includes an upper surface, a forward surface, a first portion of a left surface, and a first portion of a right surface; and the bottom section casing includes a lower surface, a rearward surface, a second portion of a left surface, and a second portion of a right surface.

In this or other embodiments, the first part of the bottom section casing includes a first portion of the lower surface, a first portion of the rearward surface, and the second portion of the left surface; and a second part of the bottom section casing includes a second portion of the lower surface, a second portion of the rearward surface, and a second portion of the right surface.

Here the first portion of the lower surface comprises a first half portion of the lower surface; the second portion of the lower surface comprises a second half portion of the lower surface the first portion of the rearward surface comprises a first half or the rearward surface and the second portion of the rearward surface comprises a second half of the rearward surface.

In this and other embodiments at least one planar surface of the instrument enclosures contain one or more windows that are transparent and exhibit durability that minimize or eliminate breakage of the windows.

In this and other embodiments the windows are composed of tempered glass.

In a further embodiment there is a method of providing one or more one or more modular multi-configurational instrument enclosures that enclose and protect one or more field instruments at a desired location, the method comprising:
hinging a hinged section of an instrument enclosure to a vertical support section that is self-standing and/or secured to stand vertically, including a pipe stand, located in the desired location wherein the hinging enables the hinged section to rotate relative to the vertical support section between a closed position and one or more open positions of the instrument enclosures such that one or more instruments mounted within the one or more instrument enclosures are also capable of rotation or other position adjustments and wherein a combination of the vertical support section and the hinged section, in a closed position defines an enclosed space that is dimensioned to receive the one or more field instruments and wherein the one or more instrument disclosures are constructed in order to provide a protective barrier between an enclosed space and an external environment wherein the instrument enclosures are located such that the protective barrier shields the enclosed space from one or more environmental elements; and;
affixing the one or more field instruments to one or more supporting structures wherein the field instruments are disposed in a desired, particular position within the enclosed space such that the instrument enclosure is attached to the vertical support section wherein the hinged section is hinged to the vertical support section and the instrument enclosures are enclosed within a closed portion of the instrument enclosures.

Here there is also the possibility of providing a sequence of performing the hinging, the attaching, and the supporting includes a sequence selected from the group consisting of:
hinging, attaching, and supporting; attaching, hinging, and supporting; supporting, hinging, and attaching; and
supporting, attaching, and attaching.

In yet a further embodiment, it is possible to form the fixed section by fastening a first part of the hinged section to a second part of the hinged section.

In another embodiment supporting field instruments comprise performing an operation to provide support from the group consisting of:
attaching the field instruments to the vertical support structure, wherein the instrument enclosure defines an aperture configured to receive a terminal portion of the vertical support structure;
allowing for rotation and/or other positioning of the field instruments within the instrument enclosures and attaching the field instruments to one or more attachment features of the instrument enclosure.

To improve operations and avoid the lack of “on site” experience with installations it is imperative that field installation contractors have a simple solution and be able to recognize and utilize a modular expandable design that will accomplish the needs of each installation for each contractor as well as solve the need for each and every installation. This ubiquitous enclosure approach includes the ability to provide all of the tubing, heated bundles, and pipe configurations that will be required to properly mount the instrument(s), plumb the instrument(s) impulse tubing and also accomplish any blow down tubes required to clear the instrument impulse tube from scale or other build up that occurs in normal operation of a power plant, refinery, or petrochemical facility. Ultimately, the need often includes calibration of the instrument(s) so that the instrument(s) can be tied into the Distributive Control System (DCS) which is the backbone of any complex operating facility.

The modular and multi-configurable instrument enclosure which is attached via bracket to an enclosure-supportive pipe stand, provides the capability for two instrument-supportive pipe stand entries, with pre-determined/supplied orifice (aperture) dimensions engineered for use with either rigid or flexible conduits. It is also possible that these orifices be used for inserting tubing that penetrates through the enclosure for blow down needs. The modular and multi-configurable instrument enclosure places pre-set orifices (apertures) both at the bottom of the enclosure just in front of the enclosure-supportive pipe stand for ease of blow down tubing to be routed from the instrument manifold directly below the typical instrument mounting location. In this manner, the enclosure using the pre-set orifices (apertures) allows for simple and clear standardized installation for single-and multi-instrument applications utilizing a single enclosure.

Here the disclosed modular multi-configurational instrument enclosure solves another field installation inconsistency by using dual post pipe stands to which the enclosure will mount. Because the enclosure will need multiple instrument-supportive pipe stands to allow for entry into the space provided inside of the enclosure that allows for multiple instruments to be mounted, the pipe stand must enter the enclosure at a precise location and at a precise angle. To implement this positioning, the modular multi-configurational instrument enclosure utilizes a horizontal adjustable bracket to which two vertical instrument-supportive pipe stands are mounted. In the past with other non-modular non-expandable enclosure designs this was essentially an impossible task in that the standard fabricated “goal post” style pipe stands required fabricators to weld the double “goal post” to a flat horizontal pipe. In this case, it was a difficult to obtain and rarely achieved ability to provide the vertical “goal post” pipes at the precise (more perfect) angle of entry and also to provide a reproducible and consistent location of the enclosure with respect to the second vertical pipe. In the present disclosure, we provide a double offset from the center instrument-supportive pipe stands. Here, the tolerance requirements for the pipe stand entry location is governed by the rigid plastic bottom sections with extremely precise orifice (aperture) locations utilizing the ability provided by plastic injection molding. This newly created modular multi-configurational instrument enclosure addresses and solves the problems associated with pipe fabrication and welding that always creates inconsistent instrument-supportive pipe stand penetration points and angles. This precision is required during installation so that the bottom sections of the enclosure to properly come together and seal to prevent moisture and dust ingress.

The modular multi-configurational instrument enclosures further address problems that may arise with typical rigid or soft cover enclosures. These modular multi-configurational instrument enclosures allow for a field instrument that is mounted directly to a standing structure, such as a conventional 2″ pipe stand or the like, to be enclosed, in the field, within an enclosed space defined by the instrument enclosure, thereby beneficially enabling contractors to improve their productivity during original installation and eliminate the practice of providing expensive and often proprietary instruments to a box manufacturer and then waiting for the assembled instrument and instrument enclosure assemblies to arrive back at the site to then be installed. Disclosed instrument enclosures save time during original installation because disclosed instrument enclosures do not require mounting all components and the field instrument to the instrument enclosure and then mounting the instrument enclosure on the pipe stand or other structure. The modular multi-configurational instrument enclosures may be replaced without taking the field instrument offline and the time required to replace disclosed instrument enclosures is much less than time required to replace conventional rigid enclosures.

With respect to soft removable cover enclosures, disclosed instrument enclosures provide at least the following advantages: The modular multi-configurational instrument enclosures can be mounted directly to a supporting structure, like the field instrument itself, and will allow direct access to the field instrument without having to completely remove a custom fitted cover. The modular multi-configurational instrument enclosures are more likely to be replaced properly should a replacement be required whereas the soft removable covers are difficult to re-install properly once they have been removed from the field instrument, due to their custom fitted profiles. The modular multi-configurational instrument enclosures may reduce or eliminate expensive travel and the tedious process of walking around the applicable facility to first locate each instrument and then creating a custom template. The modular multi-configurational instrument enclosures can also be used for covering inline instruments, valves, regulators, and other appurtenances that would be needed to maintain a specified thermal profile.

The modular multi-configurational field-mounted instrument enclosures, including rigid and semi-rigid enclosures, protect field instruments from ambient conditions by providing a barrier between the enclosed space and the environment external to the enclosed space. The barrier shields the enclosed space from one or more environmental elements including, as non-limiting examples and depending on the embodiment, precipitation, humidity, wind, sunlight, environmental debris, wild animals, and unauthorized persons. Embodiments may employ seals, gaskets, or the like using known materials such as silicon or silicon-based compounds to improve the moisture barrier provided by the instrument enclosure in the closed position. Embodiments allow a universally sized box to completely enclose a field instrument without taking the field instrument off-line, removing the field instrument from a pipe stand mount, or mounting the field instrument within an instrument enclosure using various brackets.

The modular multi-configurational instrument enclosures may include a top casing, also sometimes referred to herein as a hinged section, and a bottom casing, also referred to herein as a fixed section. The bottom section may include two parts, which may be hinged or affixed in a manner that permits the bottom to be opened and wrapped around a field instrument or other object mounted to a pipe or a pipe stand. The two parts of the bottom section may be configured to wrap around a portion of the pipe stand or other support, a portion of the tubing or tubing bundle carrying a process fluid, and a portion of any power wire(s) and/or communication wire(s) fixed to the field instrument.

For the present disclosure, the double instrument enclosure has two pipe entries. The center bottom section mounts to both entries, instead of a single entry. For the triple instrument enclosure there are two center sections, and three pipe stand entries. Here, one pipe stand entry could be a straight pipe stand from the floor to the top section inside the enclosure, while the other two would be supported from the horizontal section+the vertical pipe stand section which penetrate the instrument enclosure(s). For this design, it is important to understand that the top sections now match the bottom sections—there is a one-to-one correspondence. Therefore, these designs require a double instrument enclosure with three bottom sections and three top sections, and a triple instrument enclosure (system) will have four bottom sections and four top sections. For clarity, the single instrument enclosure includes two bottom sections to ensure modular and configurable installation.

The modular multi-configurational instrument enclosures may further include a hinge or fasteners which are suitable for attaching the top section of the instrument enclosure to the bottom section once the bottom section is in place.

Accordingly, for the single instrument enclosure the subject matter disclosed herein includes a modular multi-configurational instrument enclosure comprising a top section, a bottom section including a first part and a second part, one or more fasteners for fastening the first part to the second part, and one or more hinges configured to hinge the top section to the bottom section.

The bottom section may be suitably configured to readily attach directly to a pipe stand or directly to a bracket that is affixed to the pipe stand. In at least one embodiment, the hinges enable the top section to rotate, relative to the bottom section, wherein an angle formed by an edge of the top section and a corresponding edge of the section varies between 0 degrees in the closed position and N degrees in the open position where N can vary between 90 to 270 in some embodiments and N can vary between two different angles in other embodiments. In the closed position, edges of the top section are in contact with or in very close proximity to corresponding edges of the bottom section, and the combination of the top section and the bottom section define an enclosed space that is suitable for receiving a field instrument.

The opening in the bottom section may be sized and otherwise configured to engage a pipe stand, the opening is standardized to the size of all other openings. The post mount bracket fits in this standard size opening and holds the pipe stand. This bracket can be reconfigured for any necessary changes required for pre, during or post installation, in which case an end portion of the pipe stand may reside within the enclosed space defined by the top and bottom sections of the instrument enclosure in the closed position. In these embodiments, the field instrument, when installed, may be affixed to the end portion of the pipe stand and the enclosed space is suitably sized to receive the field instrument affixed to the end portion of the pipe stand.

One or more interior surfaces of enclosed space defined by the instrument enclosure, including, but not limited to, one or more interior surfaces of the bottom section, may include one or more instrument attachment elements to which one or more attachment elements or features of the field instrument may attach. In at least some embodiments, the attachment elements may be sufficient in number, position, strength, and other relevant parameters to fully support the field instrument. In such embodiments, the pipe stand may terminate outside of the instrument enclosure and the enclosed space may not need to accommodate an end portion of the pipe stand. In these embodiments, the instrument enclosure may be configured to attach to a mounting plate, bracket, or other suitable structure that is itself, affixed to the pipe stand.

In some embodiments, one or more openings in the bottom section may be configured to receive one or more process line conduits for carrying, communicating, or otherwise conveying one or more measurable process parameters to the field instrument.

Such conduits may be enclosed in suitable process line tubing. In still other embodiments, the instrument enclosure may include a first opening configured to receive a pipe stand and a second opening configured to receive one or more process line conduits and, in these embodiments, the pipe stand opening may be located in a different surface of the instrument enclosure.

As a non-limiting example, the pipe stand opening may be disposed in a horizontally oriented lower surface while the conduit opening is disposed in a vertically oriented reward surface of the instrument enclosure.

In further embodiments of the modular multi-configurational instrument enclosure that include a first opening for a pipe stand and a second opening for one or more process line conduits, the first part of the bottom section may include or define a first pipe notch and a first line notch while the second part of the bottom section may include or define a second pipe notch and a second line notch. In these embodiments, the first pipe notch and the second pipe notch may be positioned, sized, and otherwise configured wherein the combination of the fist pipe notch and the second pipe notch define the pipe stand opening when the first part and the second part are properly fastened together while the first line notch and the second line notch are positioned, sized, and otherwise configured wherein the combination of the first line notch and the second line notch define the process line opening when the first part and the second part are properly fastened together.

In some instrument enclosure embodiments, including embodiments that lack a pipe opening, the bottom section may be configured to be fastened to a mounting plate or bracket that is affixed or that is readily affixed to the pipe stand.

In such embodiments, the mounting plate or bracket may include a plurality of openings suitable for receiving bolt, screws, pins, or other suitable fasteners, in which case, the bottom section of the instrument enclosure may include a corresponding plurality of openings for receiving the bolts, screws, pins, or other suitable fasteners.

In some embodiments, the instrument enclosure is a convex polyhedral instrument enclosure comprising a plurality of planar or substantially planar surfaces or walls. Convex polyhedral embodiments of the instrument enclosure may include hexahedral embodiments, comprising six planar surfaces including an upper surface and a lower surface that are oriented in parallel or substantially parallel planes, a forward surface and a rearward surface that are oriented in parallel or substantially parallel planes that are perpendicular or substantially perpendicular to the upper surface, and a left surface and a right surface that are oriented in parallel or substantially parallel planes that are perpendicular or substantially perpendicular to the upper surface and the forward surface.

In some hexahedral embodiments, the top section of the instrument enclosure includes the upper surface, the forward surface, a first portion of the left surface, and a first portion of the right surface while the bottom section includes the lower surface, the rearward surface, a second portion of the left surface and a second portion of the right surface. In these embodiments, the first part of the bottom section may include a first portion of the lower surface, a first portion of the rearward surface, and the second portion of the left surface while the second part of the bottom section may include a second portion of the lower surface, a second portion of the rearward surface, and the second portion of the right surface.

The first and second parts of the bottom section may be configured as mirror images of one another or substantially so. The first portion of the lower surface may comprise a first half of the lower surface while the second portion of the lower surface may comprise a second half of the lower surface. Similarly, the first portion of the rearward surface may comprise a first half of the rearward surface and the second portion of the rearward surface may comprise a second half of the rearward surface.

Embodiments of the instrument enclosure, including embodiments of hexahedral and other convex polyhedral instrument enclosures may include one or more durable and transparent or partially transparent windows of tempered glass or other suitable material.

In further accordance with disclosed subject matter, a disclosed method of providing an instrument enclosure suitable for enclosing a field instrument located at a desired site includes hinging a top section, also referred to herein as the hinged section, of an instrument enclosure to a bottom section, also referred to herein as the standing section, of the instrument enclosure to enable the hinged section to rotate, relative to the standing section, between a closed position and one or more open positions. When the instrument enclosure is in the closed position, the combination of the standing section and the hinged section define an enclosed space that is suitably dimensioned to receive a field instrument and suitably constructed to provide a barrier between the enclosed space and the external environment in which the instrument enclosure is located. The barrier shields the enclosed space from one or more environmental elements.

The method further includes attaching the standing second to a standing structure located at or within the site and affixing the field instrument to a supporting structure such that the field instrument is positioned in a particular position disposed within the enclosed space when the instrument enclosure is closed. The supporting structure may be the pipe stand or attachment elements disposed in or on an interior surface of the enclosed space defined by the instrument enclosure in the closed position.

Embodiments of the method support substantially any sequence for hinging the hinged section, attaching the fixed section, and affixing the field instrument to a supporting structure, such that any of the following sequences may be followed: hinging, attaching, and supporting; attaching, hinging, and supporting; supporting, hinging, and attaching; and supporting, attaching, and hinging.

The method may further include forming the fixed section by fastening a first part of the fixed section to a second part of the hinged section. Affixing the field instrument to the supporting structure may include affixing the field instrument to the standing structure, in which case the instrument enclosure may include or define an aperture sized, positioned, and otherwise configured to receive a terminal portion of the standing structure within the enclosed space. Affixing the field instrument may alternatively include attaching the field instrument to one or more attachment features of the instrument enclosure, in which case the fixed portion of the instrument enclosure may be affixed to the pipe stand or to a brace, bracket, or mounting plate attached to the pipe stand.

### BRIEF DESCRIPTION OF THE DRAWINGS

FIG. 1 depicts a modular multi-configurable instrument enclosure for use with a single, double, and triple set of instruments as possible configurations.

FIG. 2 provides a single instrument configuration of the modular multi-configurable instrument enclosure in the open position affixed to a pipe stand or other suitable standing structure onto which the instrument enclosure mounts.

FIG. 3 illustrates a partially exploded view of the single instrument configuration of a modular multi-configurable instrument enclosure having a horizontal arrangement.

FIG. 4 illustrates a partially exploded perspective view of a single instrument configuration of the modular multi-configurable instrument enclosure having a horizontal arrangement in the closed position.

FIG. 5 illustrates a partially exploded isometric view of the closed single instrument configuration of the modular multi-configurable instrument enclosure having a horizontal arrangement.

FIG. 6 illustrates a partially exploded isometric view of the closed single instrument configuration of the modular multi-configurable instrument enclosure having a vertical arrangement.

FIG. 7 illustrates an isometric view of the single instrument configuration of the modular multi-configurable instrument enclosure having a horizontal arrangement in the closed position.

FIG. 8 illustrates an isometric view of the single instrument configuration of the modular multi-configurable instrument enclosure having a vertical arrangement in the closed position.

FIG. 9 provides the horizontal arrangement of a double instrument configuration of the modular multi-configurable instrument enclosure in the open position affixed to a pipe stand or other suitable standing structure onto which the instrument enclosure mounts.

FIG. 10 illustrates an exploded view of the double instrument configuration of a modular multi-configurable instrument enclosure having a horizontal arrangement.

FIG. 11 illustrates a partially exploded view of the double instrument configuration of a modular multi-configurable instrument enclosure, depicting the fitting together of interchangeable windows and brackets utilized in a horizontal arrangement.

FIG. 12 illustrates a front bottom perspective view of the double instrument configuration of a modular multi-configurable instrument enclosure having a horizontal arrangement in a closed position affixed to a pipe stand or other suitable standing structure.

FIG. 13 illustrates a close-up view of the conduit housing and conduit seals for a modular multi-configurable instrument enclosure.

FIG. 14 provides a perspective view of a conduit housing with conduit seal.

FIG. 15 illustrates and isometric view of a conduit housing with conduit seal.

FIG. 16 illustrates a cross-sectional view of a conduit housing with conduit seal.

FIG.17 provides an exploded view of a conduit housing with conduit seal.

FIG. 18 illustrates a rear perspective view of the double instrument configuration of a modular multi-configurable instrument enclosure having a horizontal arrangement in a closed position affixed to a pipe stand or other suitable standing structure.

FIG. 19 illustrates a close-up view of the interchangeable window bracket that is a cap on a bundle bracket. It is possible to cap any of the pre-set orifices and cap the window openings if no windows are used for this modular multi-configurable instrument enclosure.

FIG. 20 illustrates a front perspective view of the double instrument configuration of a modular multi-configurable instrument enclosure having a horizontal arrangement in a closed position affixed to a pipe stand or other suitable standing structure.

FIG. 21 illustrates a front bottom perspective view of the double instrument configuration of a modular multi-configurable instrument enclosure having a horizontal arrangement in a closed position is affixed by a mounting system to a pipe stand or other suitable standing structure.

FIG. 22 illustrates the detailed rear perspective view of a double-instrument configuration of the modular multi-configurable instrument enclosure in which the instrument enclosure is affixed by a mounting system to a pipe stand or other suitable standing structure;

FIG. 23 illustrates the rear bottom perspective view of a double-instrument configuration of the modular multi-configurable instrument enclosure in which the instrument enclosure is affixed by a mounting system to a pipe stand or other suitable standing structure;

FIG. 24 illustrates a perspective view of a horizontally arranged double-instrument configuration of the modular multi-configurable instrument enclosure in an open configuration prior to the inclusion of field instrumentation.

FIG. 25 depicts a cross-sectional view of a double instrument configuration of the modular multi-configurable instrument enclosure having a horizontal arrangement.

FIG. 26 depicts a cross-sectional view of a double instrument configuration of the modular multi-configurable instrument enclosure having a horizontal arrangement at the junction of the center components and the left wing components.

FIG. 27 depicts a cross-sectional view of a double instrument configuration of the modular multi-configurable instrument enclosure having a horizontal arrangement.

FIG. 28 depicts a rear perspective view of a double instrument configuration of the modular multi-configurable instrument enclosure having a vertical arrangement.

FIG. 29 illustrates a frontal view of a vertically arranged double-instrument configuration of the modular multi-configurable instrument enclosure in an open configuration prior to the inclusion of field instrumentation.

FIG. 30 depicts a front bottom perspective view of a double instrument configuration of the modular multi-configurable instrument enclosure having a vertical arrangement.

FIG. 31 depicts a rear bottom perspective view of a double instrument configuration of the modular multi-configurable instrument enclosure having a vertical arrangement.

FIG. 32 provides the horizontal arrangement of a triple instrument configuration of the modular multi-configurable instrument enclosure in the open position affixed to a pipe stand or other suitable standing structure onto which the instrument enclosure mounts.

FIG. 33 illustrates an exploded view of the triple instrument configuration of a modular multi-configurable instrument enclosure having a horizontal arrangement.

FIG. 34 illustrates a partially exploded view of the triple instrument configuration of a modular multi-configurable instrument enclosure, depicting the fitting together of interchangeable windows and brackets utilized in a horizontal arrangement.

FIG. 35 illustrates a frontal view of a triple-instrument configuration of the modular multi-configurable instrument enclosure in which the instrument enclosure is attached by a mounting system to a pipe stand or other suitable standing structure;

FIG. 36 illustrates the rear view of a triple-instrument configuration of the modular multi-configurable instrument enclosure in which the instrument enclosure is attached by a mounting system to a pipe stand or other suitable standing structure;

FIG. 37 illustrates a frontal view of a triple-instrument configuration of the modular multi-configurable instrument enclosure in an open configuration prior to the inclusion of field instrumentation.

FIG. 38 is a schematic diagram that illustrates the attachment aperture and interchangeable port positioning of the multi-configurable single instrument enclosure.

FIG. 39 is a schematic diagram that illustrates the attachment aperture and interchangeable port positioning of the multi-configurable double-instrument enclosure.

FIG. 40 is a schematic diagram that illustrates the attachment aperture and interchangeable port positioning of the multi-configurable triple-instrument enclosure.

The figures and corresponding text disclose non-limiting examples and embodiments. Reference numerals used in different figures represent similar structures or procedures unless denoted otherwise. Features shown may be enlarged or reduced relative to other features for clarity or emphasis to ensure better understanding.

### DETAILED DESCRIPTION

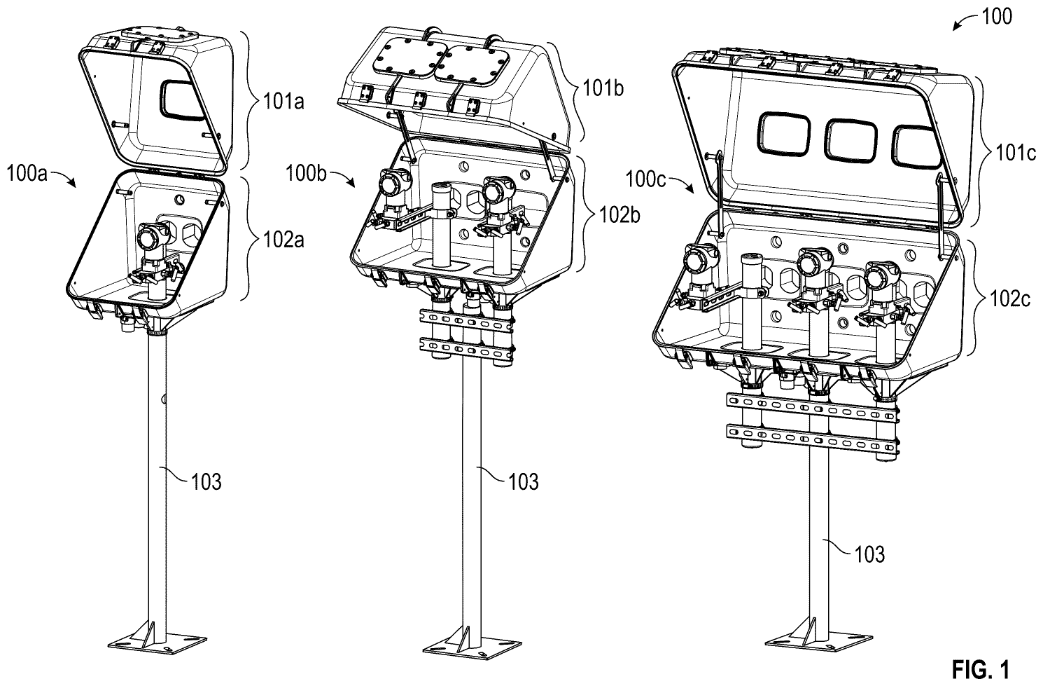

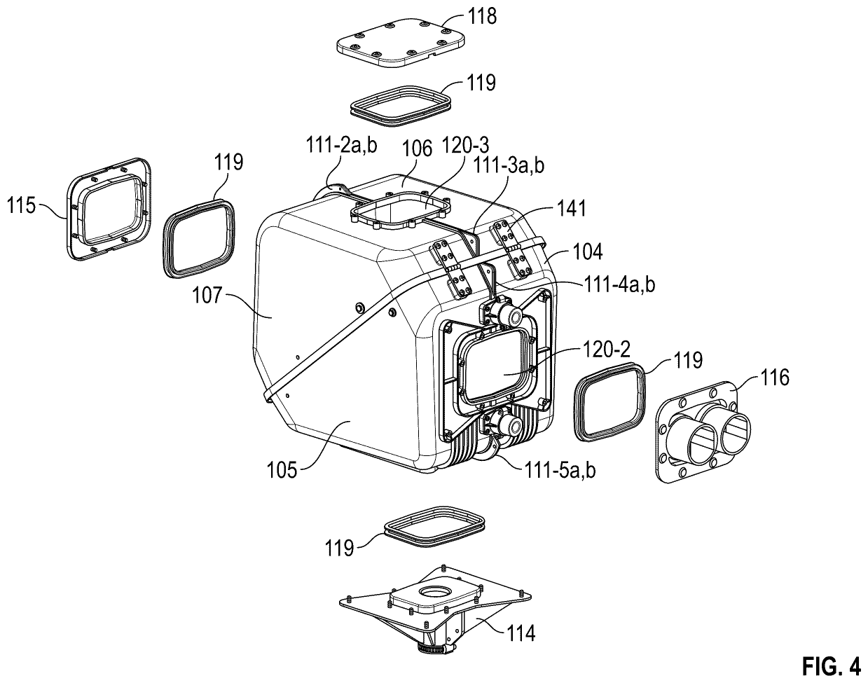

The modular multi-configurable instrument enclosure of FIG. 1 is shown providing either a single, double, or triple configuration [100a, 100b, 100c]. Each muti-configurable instrument enclosure [100] is affixed to an enclosure-supportive pipe stand [103]. The top casing [101] is a “hinged section” as it is able to open and close on a hinge [141] (as shown in FIG. 4), and the

bottom casing [102] is a “fixed section” that is secured and does not move or rotate. The single configuration [100a] is constructed using a 1-3 arrangement of the top and bottom casings [101a, 102a], the double configuration [100b] is constructed using a 1-2-3 arrangement of the top and bottom casings [101b, 102b], and the triple configuration [100c] is constructed using a 1-2-2-3 arrangement of the top and bottom casings [101c, 102c], each configuration utilizing interchangeable components.

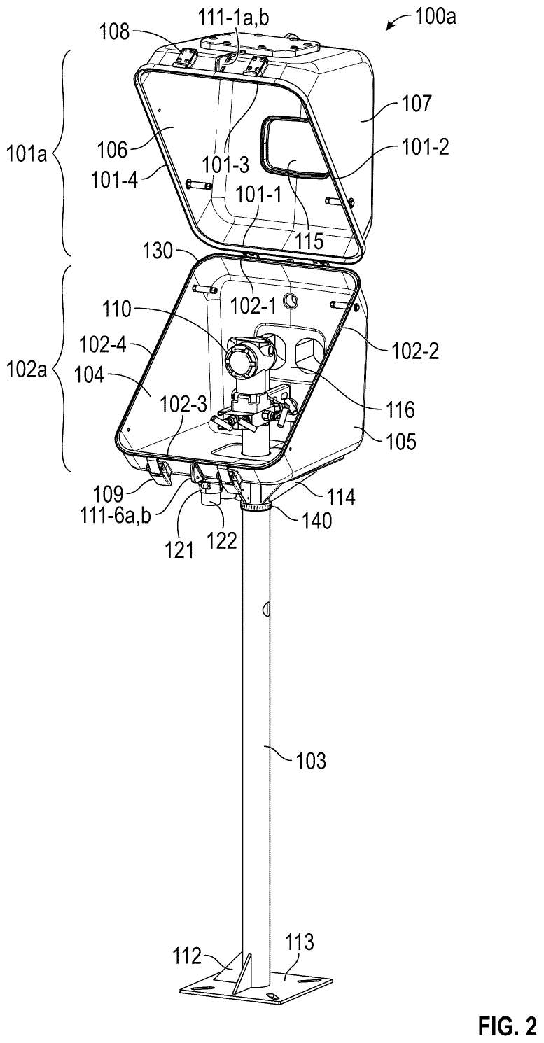

The single configuration [100a], as depicted in FIG. 2, is completed using a 1-3 arrangement for the top and bottom casings [101a, 102a], where the first component is a right wing component [bottom 104, top 106], termed ‘1’, and where the second component is a left wing component [bottom 105, top 107], termed ‘3’, providing LEFT ‘1’ [104, 106]-RIGHT ‘3’ [105, 107] or the 1-3 arrangement (1-3). The top casing [101a] is assembled using the top right wing [106] and the top left wing [107] each section having a top portion of a latching mechanism [108], and the bottom casing [102a] is assembled using the bottom right wing [104] and the bottom left wing [105] each section having a bottom portion of a latching mechanism [109]. The left and right wings [104, 106 and 105, 107] are joined by carefully aligned apertures [111, 111-1a,b and 111-6a,b shown], where 111-1a,b consists of the joining of aperture 111-1a to aperture 111-1b and 111-6a,b consists of the joining of aperture 111-6a to aperture 111-6b, using suitable fasteners, such as nuts and bolts (not shown).

The single configuration [100a] of the modular multi-configurable instrument enclosure [100] is affixed to an enclosure-supportive pipe stand [103] or other suitable standing structure, having fixed pipe stand supports [112], and secured to a mounting plate [113] that can be secured to a floor, wall, ceiling, or other planar, stable surface.

The completed enclosure [100] has been carefully designed and engineered to contain components that fit interchangeably into specific recesses of the enclosure. These interchangeable window brackets (the post mount bracket [114], window [115], and tube bundle bracket [116]) can change in position to any of these specific recesses, allowing an additional configuration of a horizontal or vertical construction. The post mount bracket [114], having a support clamp [140] that supports the bottom casing [102] and prevents vertical movement of the instrument enclosure [100]. The window [115] provides a panel through which instruments can record data. The tube bundle bracket [116] provides entrance for process line tubing and other lines, tubes, and cables to enter the enclosure.

A field instrument [110] can be directly mounted, affixed, or otherwise attached to the enclosure-supportive pipe stand [103] or other suitable standing structure that limits contact of the field instrument [110] with the instrument enclosure [100]. In the single configuration [100a], the enclosure-supportive pipe stand [103] also acts as an instrument-supportive pipe stand.

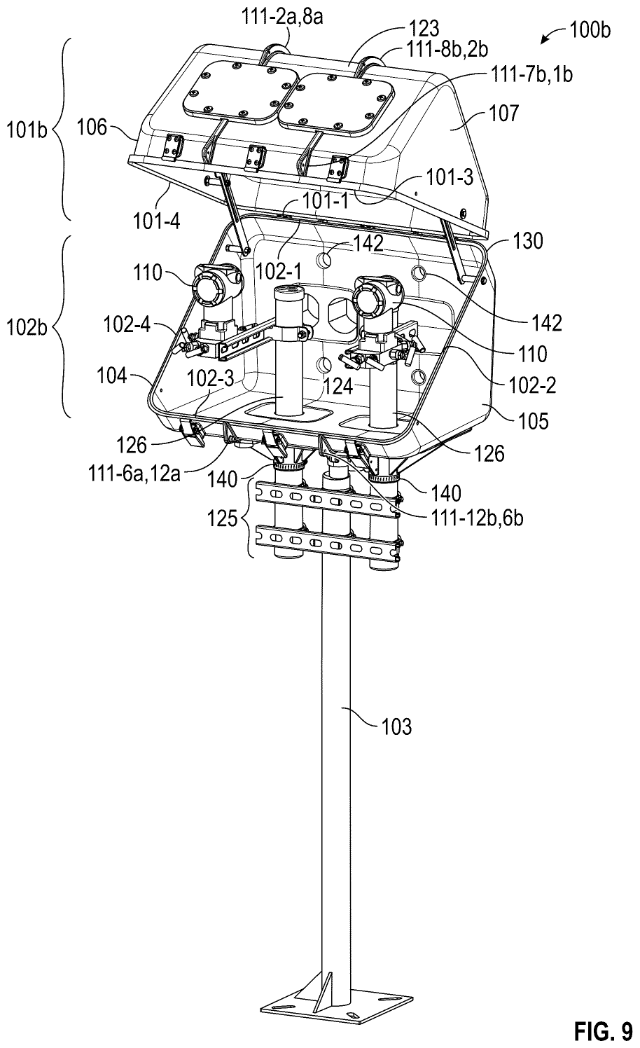

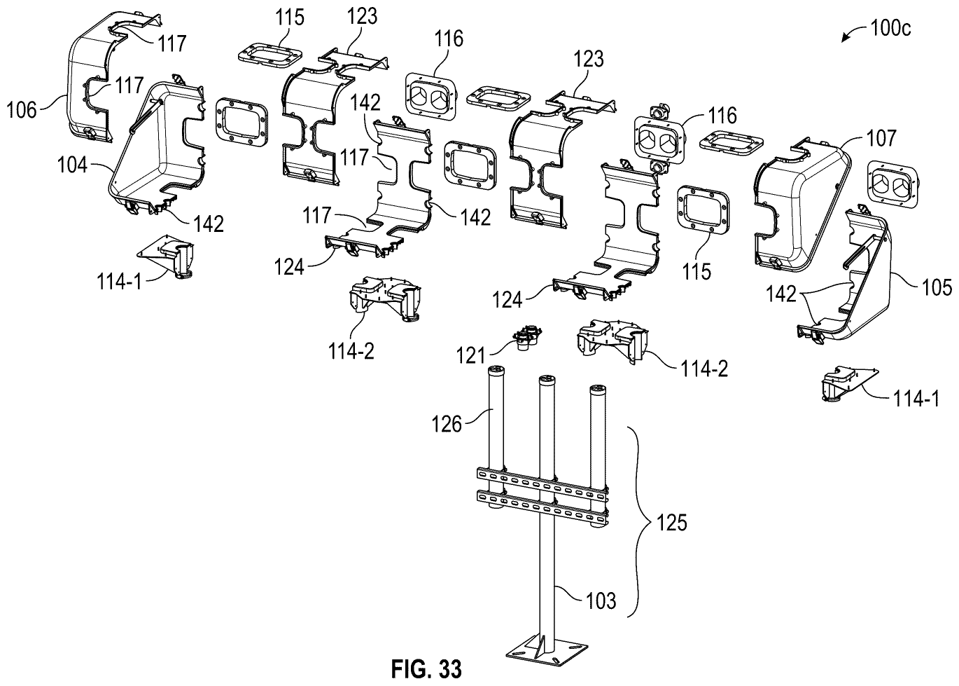

In addition, the illustrated field instrument [110] is attached to process line tubing (not shown) by a tube bundle bracket [116], configured to provide process flow, as well as measurable parameters, to the field instrument [110], or through conduit penetration housing(s) [121], which when not in use are sealed with a conduit penetration housing cap [122]. The conduit penetration housing [121] is sealed within the enclosure using pre-engineered holes. The rigid or semi-rigid instrument enclosure [100] is configured to be attached to an enclosure-supportive pipe stand [103] or mounting system [125], as used in a double (FIG. 9) or triple-configuration (FIG. 33), such that the instrument enclosure [100] encompasses the field instrument [110] while permitting the ability for ingress/egress of the process line tubing (not shown here).

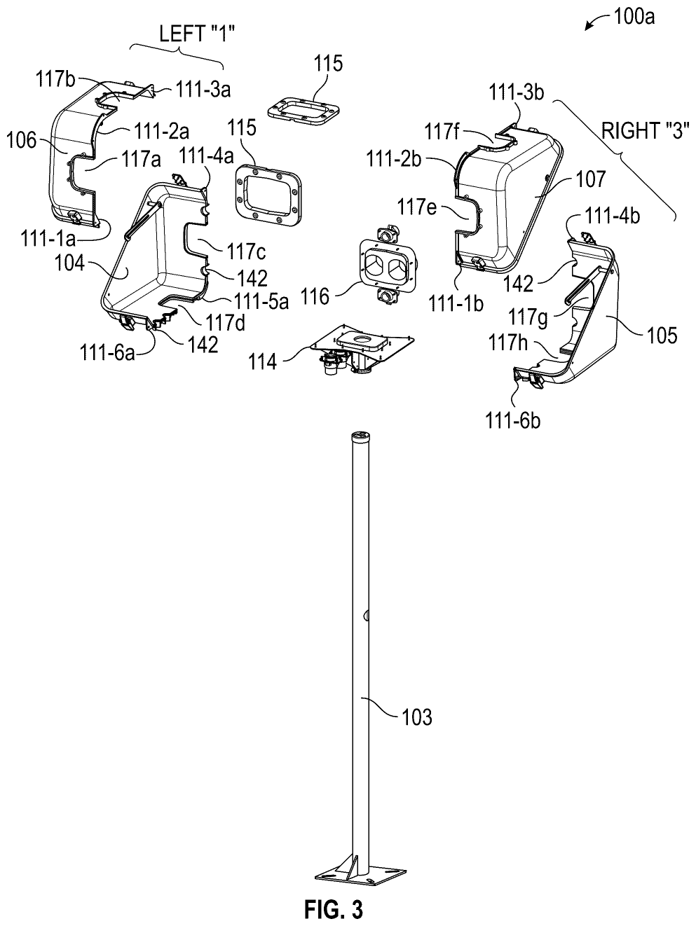

FIG. 3 and FIG. 4. provide partially exploded views of a single instrument configuration [101a] of the modular multi-configurable instrument enclosure [100]. The left and right wings [104, 105, 106, 107] are mirrored in design, and therefore are arranged in a reverse configuration when compared to the other, with the top wings [106, 107] having surfaces containing arched recesses [117] to receive the interchangeable post mount bracket [114], window [115], tube bundle bracket [116], plug panel [118], and associated gaskets [119]. Once the casings [101a, 102a] are attached using the aligned apertures [111-1a,b, 111-2a,b, 111-3a,b and 111-4a,b, 111-5a,b, 111-6a,b], the arched recesses [117, provided as 117a-117h], when joined, form component ports [120] and the interchangeable components [114, 115, 116, 118] become sealed within the component ports [120-1, 120-2, 120-3, 120-4] for a single instrument configuration using gaskets [119], creating a controlled interior environment for field instrumentation [110]. Component port [120-1] is formed from the alignment of arched recesses [117a] and [117e], component port [120-2] is formed from the alignment of arched recesses [117c] and [117g], component port [120-3] is formed from the alignment of arched recesses [117b] and [117f], component port [120-4] is formed from the alignment of arched recesses [117d] and [117h]. All seals [130] between top and bottom casings [101,102] are 0.188″ diameter and only utilize straight seal pieces. The top and bottom seal [130] is 0.25″×25″ square ethylene propylene diene monomer (EPDM) foam with adhesive or an appropriate alternative. This provides the ability to provide an enclosure that is an IP66 rated enclosure. This IP66 rating keeps out water and dust to the IP66 rating requirements. Sealing to meet IP66 rating for water ingress and dust ingress is critical. Gaskets are used to keep water and dust out to IP66 specs. This IP66 Rating rated enclosure provides protection against high pressure (12.5 mm or 0.49″) water jets. The test includes the enclosure being subjected to 100 liters per minute of water volume with the pressure of 100 kPa at a distance of 3 m for at least 3 minutes.

It should be noted that the same gasket [119] is used for all component port(s) [120] fittings with the bundle bracket [116], post mount bracket [114], windows and plug panel [118]. In at least one embodiment the gaskets are made from EPDM (ethylene diene propylene dimer—or synthetic rubber). It is possible other gasket materials may be necessary such as neoprene, silicone rubber or some other gasket material for certain applications.

The interchangeable features of the post mount bracket [114], window [115], tube bundle bracket [116], plug panel [118] and gaskets [119] allow the enclosure [100] to change between a horizontal or vertical construction. In some gas applications, more vertical space is required, while in most liquid applications depth not height, and therefore, more horizontal space is required. No longer does the engineer have to specify if the instrument enclosure [100] is to be mounted vertically or horizontally, the interchangeability of the brackets allows the enclosure to be mounted in the most appropriate configuration in the field, with no special added brackets. In at least one embodiment, the tube bundle bracket, post mount bracket, and window all have the exact same cut out size in the enclosure, same seal, and are interchangeable and any of the orifices can be capped as well. In addition, all hinges and latches are interchangeable so the determined hinge side will best suit the application. As the enclosure is essentially rectangular in shape, changing the position of the post mount bracket [114] from the first component port [120-1, not visible] to the second component port [120-2], and the tube bundle bracket [116] from the second component port [120-2] to the first component port [120-1], changes the positional configuration 90-degrees, from horizontal to vertical.

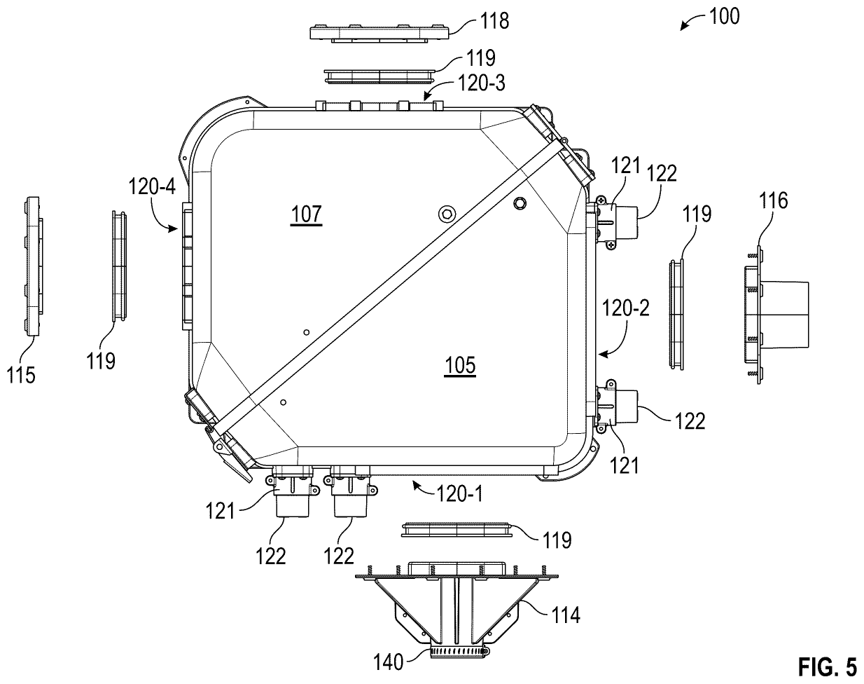

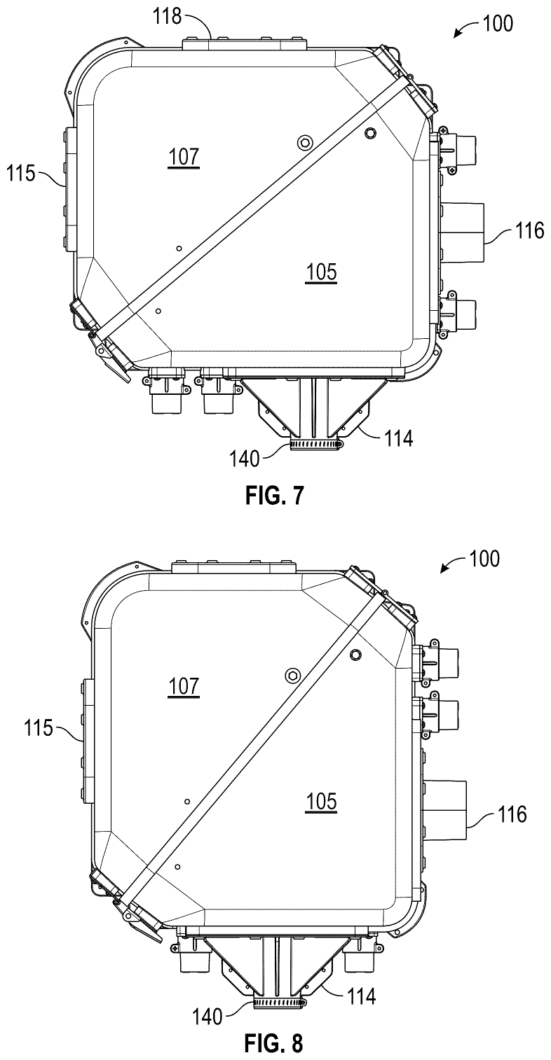

In a single-, double-, or triple-instrument enclosure arrangement [101a, 101b, 101c], the ability to mount the enclosure vertically or horizontally in the field is based on each application. FIG. 5 illustrates a partially exploded isometric side view of the single-, double-, or triple-instrument enclosure [100a, 100b, 100c] having a horizontal (wide) arrangement. Juxtaposed conduit penetration housings [121], incorporating conduit penetration housing caps [122], positioned next to the post mount bracket [114] indicates a horizontal arrangement. FIG. 7 provides a completed isometric view of the horizontal arrangement of the instrument enclosure [100].

The top casing [101] and complete bottom casing [102] are substantially triangular in cross section as best illustrated by the substantially triangular side panel of the top left wing [107] of top casing [101] and the substantially triangular side panels of the bottom left wing [105] of bottom casing [102].

The interchangeable window [115] to enable visual inspection of the instrument enclosure [100] without opening the instrument enclosure [100]. A window [115] may be comprised of tempered glass or any other sufficiently transparent and durable material.

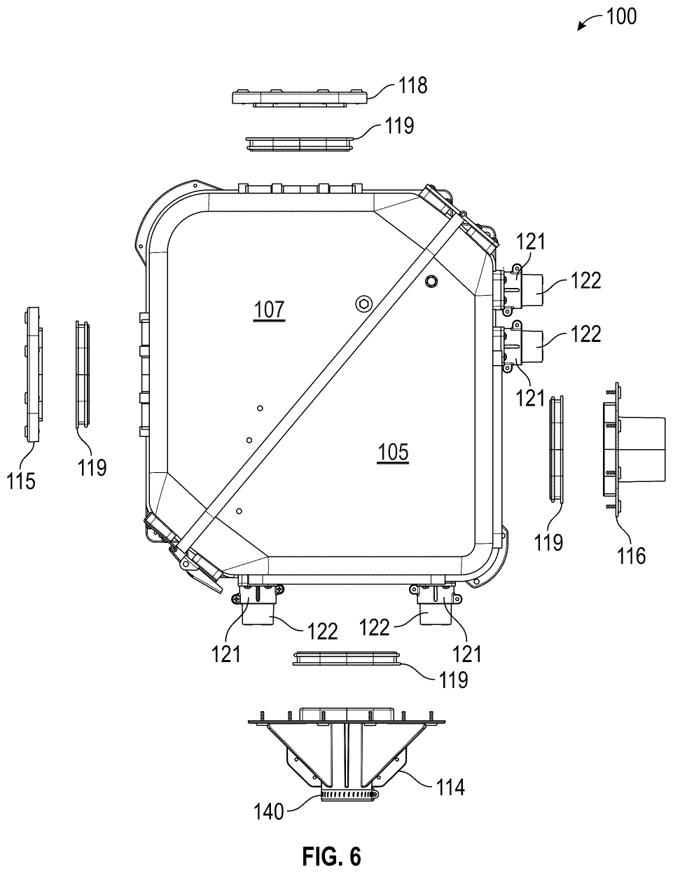

FIG. 6 illustrates a partially exploded isometric side view of the single-, double-, or triple-instrument enclosure [100a, 100b, 100c] having a vertical (tall) arrangement. Separated conduit penetration housings [121], incorporating conduit penetration housing caps [122], positioned next to the post mount bracket [114] indicates a vertical arrangement. FIG. 8 provides a completed isometric view of the vertical arrangement of the instrument enclosure [100].

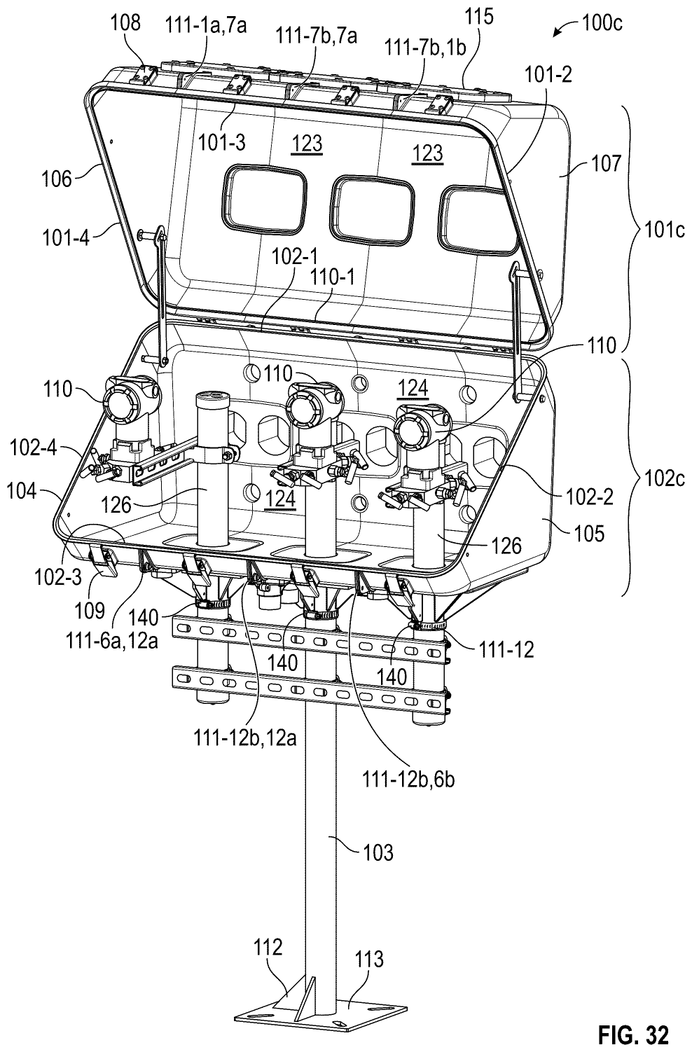

In one embodiment, as provided in FIG. 9 and FIG. 32, field instruments [110] having similar operating requirements can be used in tandem allowing more than one field instrument [110] to be included within the instrument enclosure [100].

FIG. 9 illustrates a double-instrument configuration [100b] of the modular multi-configurable

instrument enclosure [100]. The double configuration [100b] is constructed using a 1-2-3 arrangement for the top and bottom casings [101b, 102b], where the first component is a right wing component [bottom 104, top 106], termed ‘1’, the second component is a center component [bottom 123, top 124], termed ‘2’, and the third component is a left wing component [bottom 105, 107], termed ‘3’, providing LEFT (1) [104, 106]—CENTER (2) [123, 124]—RIGHT (3) [105, 107] or the 1-2-3 arrangement (1-2-3). The top casing [101b] is assembled using the top right wing [106], the top center component [123], and the top left wing [107] each section having a top portion of a latching mechanism [108], and the bottom casing [102b] is assembled using the bottom right wing [104], the bottom center component [124], and the bottom left wing [105] each section having a bottom portion of a latching mechanism [109]. The left wings [105, 107] and the left edge of the center components [123, 124] are joined by aligned apertures [111, 111-2a,8a, 111-6a, 12a, 111-7b,1b, 111-8b,2b and 111-12 shown] where 111-1a,8a consists of the joining of aperture 111-1a to aperture 111-8a, while 111-6a joins to 111-12a, 111-8b joins to 111-2b, 111-7b joins to 111-1b, and 111-12b joins to 111-6b using suitable fasteners, such as nuts and bolts (not shown). The right wings [104, 106] and the right edge of the center components [123,124] are joined by aligned apertures [111, 111-1, 111-2 and 111-6 shown] using suitable fasteners, such as nuts and bolts (not shown).

The double-instrument configuration [100b] of the modular multi-configurable instrument enclosure [100] is affixed to an enclosure-supportive pipe stand [103] or other suitable standing structure via an enclosure mounting system [125]. The enclosure-supportive pipe stand [103] has fixed pipe stand supports [112] and is secured to a mounting plate [113] that can be secured to a floor, wall, ceiling, or other planar, stable surface.

A field instrument [110] can be directly mounted, affixed, or otherwise attached to the instrument-supportive pipe stand [126] or other suitable standing structure that limits contact of the field instrument [110] with the instrument enclosure [100]. In the double configuration [100b], the enclosure-supportive pipe stand [103] does not function as an instrument-supportive pipe stand and does not enter the instrument enclosure [100].

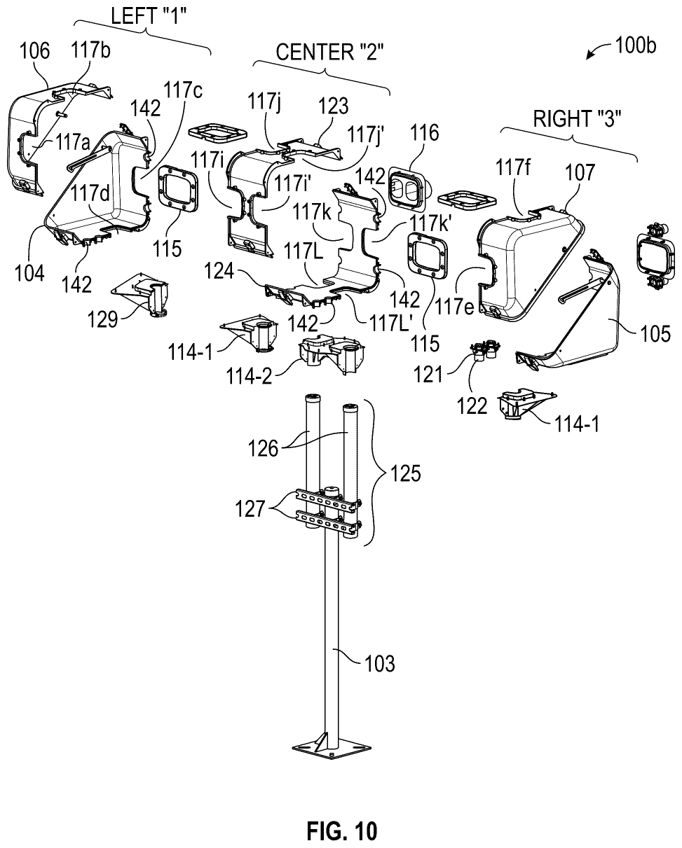

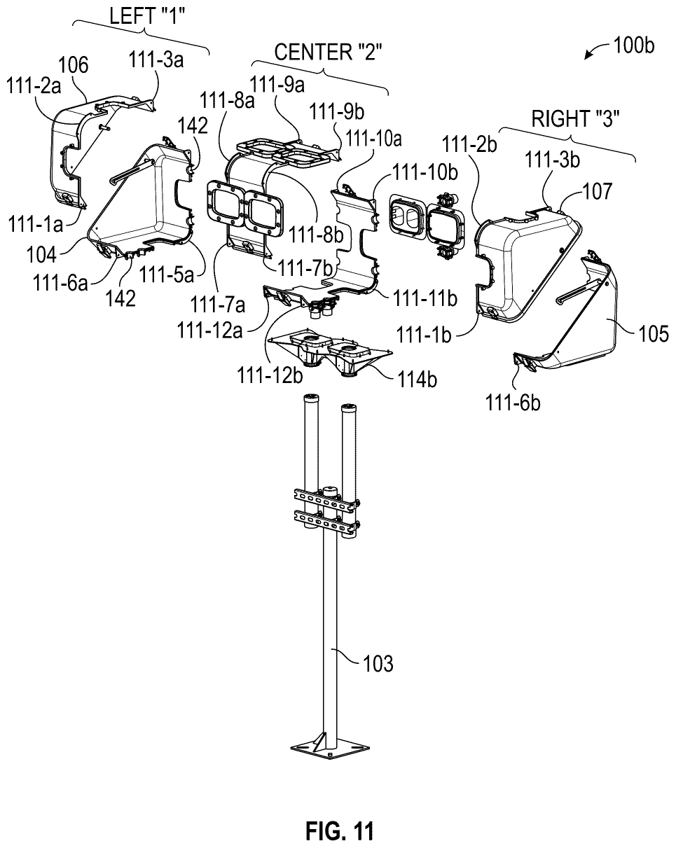

FIG. 10 and FIG. 11. provide partially exploded views of a double instrument configuration [100b] of the modular multi-configurable instrument enclosure [100]. The left and right wings [104, 105, 106, 107] and top and bottom center components [123,124] are mirrored in design, with the top wings [106, 107] and top center component [123] having surfaces containing arched recesses [117, provided as 117a-117l and corresponding 117a′-117l′] to receive the interchangeable post mount bracket [114], window [115], tube bundle bracket [116], plug panel [118], and associated gaskets [119]. Once the casings [101b,102b] are attached using the aligned apertures [111-1a,7a, 111-2a,8a, 111-3a,9a; 111-4a,10a, 111-5a,11a, 111-6a, 12a joining the RIGHT and CENTER components, while 111-7b,12a, 111-8b,2b, 111-9b,3b, 111-10b,4b, 111-11b,5b, 111-12b,6b joining the LEFT AND CENTER components], the arched recesses [117 provided as 117a-117l and corresponding 117a′-117l′] form component ports [120] and the interchangeable components [114,115,116,118] become hermetically sealed within the component ports [120-1d, 120-2d, 120-3d, 120-4d, 120-5d, 120-6d, 120-7d, 120-8d for a double instrument configuration] using gaskets [119], creating a controlled interior environment for field instrumentation [110]. Again, the goal is to meet IP66 ratings for both dust and water. All seams contain seals to meet dust and water ingress protection requirements.

Component port [120-1d] is formed from the alignment of arched recesses [117a] and [117i], component port [120-2d] is formed from the alignment of arched recesses [117b] and [117j′], component port [120-3d] is formed from the alignment of arched recesses [117c] and [117k], component port [120-4d] is formed from the alignment of arched recesses [117d] and [117l], component port [120-5d] is formed from the alignment of arched recesses [117i′] and [117e], component port [120-6d] is formed from the alignment of arched recesses [117j′] and [117f], component port [120-7d] is formed from the alignment of arched recesses [117k′] and [117g], component port [120-8d] is formed from the alignment of arched recesses [117l′] and [117h].

The addition of the top and bottom center components [123,124] to the top and bottom casings [101b, 102b] creates the need for an enclosure mounting system [125] that can support a multi-instrument enclosure. The post mount bracket [114] for the double-instrument enclosure [100b] is provided in three parts [two 114-1 and one114-2,], where post mount bracket part [114-1] is provided on each side of post mount bracket part [114-2], which when assembled provide a double post mount bracket [114b]. The double post mount bracket [114b] contains apertures for two instrument-supportive pipe stands [126], which are fastened to the enclosure-supportive pipe stand [103] by mounting brackets [127]. The mounting brackets [127] that compress against the pipe stands [103, 126], and support the instrument enclosure [100] above it, are also configurable and modular to allow for a double instrument configuration [100b], and triple instrument configuration [100c]. The enclosure mounting system [125] requires that the instrument-supportive pipe stands [103, 126] that enter into the enclosure [100], be slightly maneuverable to allow for the pipe stands [103, 126] to be positioned in the pre-set post mount bracket and enclosure holes.

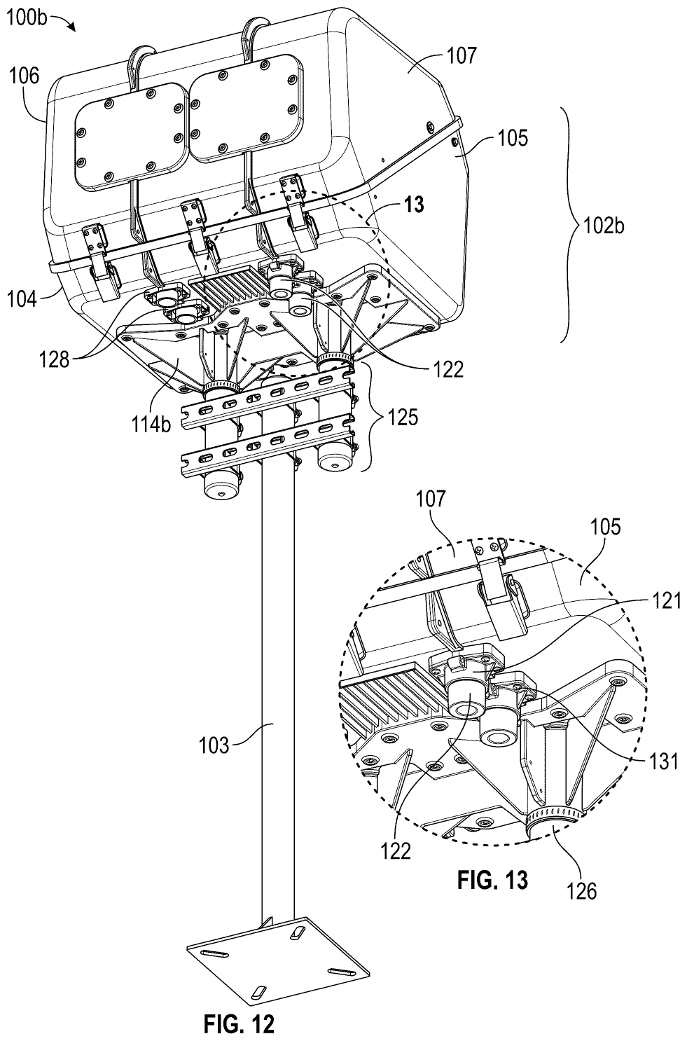

FIG. 12 illustrates a front bottom perspective view of the double instrument configuration [100b] of a modular multi-configurable instrument enclosure [100] having a horizontal arrangement in a closed position affixed to an enclosure mounting system [125] or other suitable standing structure. The double post mount bracket [114b] is shown attached, via screws or other fasteners, to the completed bottom casing [102b], with the enclosure mounting system securing two instrument-supportive pipe stands [126] to an enclosure-supportive pipe stand [103] by utilizing mounting brackets [127]. The conduit penetration housing caps [122] and pre-set embossments [128] are positioned to the front of the double post mount bracket [114b]

FIG. 13 illustrates a close-up view of the installed conduit penetration housings [121] and conduit penetration housing caps [122] for a modular multi-configurable instrument enclosure [100]. Conduit housing penetration caps [122] are incorporated within separate conduit penetration housings [121] that are attached to the instrument enclosure [100] via pre-set embosses [128] that are formed during manufacturing. These pre-set embossments [128] allow for a mounting screw [131] to screw in, or a heat insert to be utilized to allow for the conduit penetration housings [121] to be fixed to the instrument enclosure [100] at the exact locations of the conduit penetrations. Conduit penetration housings are required to secure the conduit (not shown) to the enclosure section. Conduit penetration housing [121] entries are sealed when the entries are capped using a conduit penetration housing cap [122]. These conduit penetration housings [121] serve the purpose of securing the conduit (not shown) to the enclosure [100] and provide a seal around the conduit penetration section. These conduit penetration housings [121] also utilize a sealing conduit penetration housing cap [122] if that pre-set orifice is not needed for conduit entry, some other tubing, or some piping entry into the enclosure.

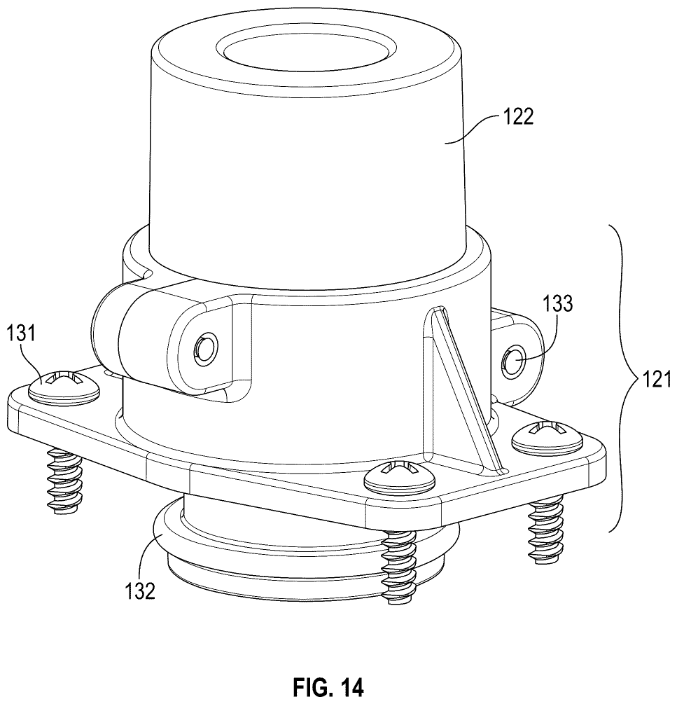

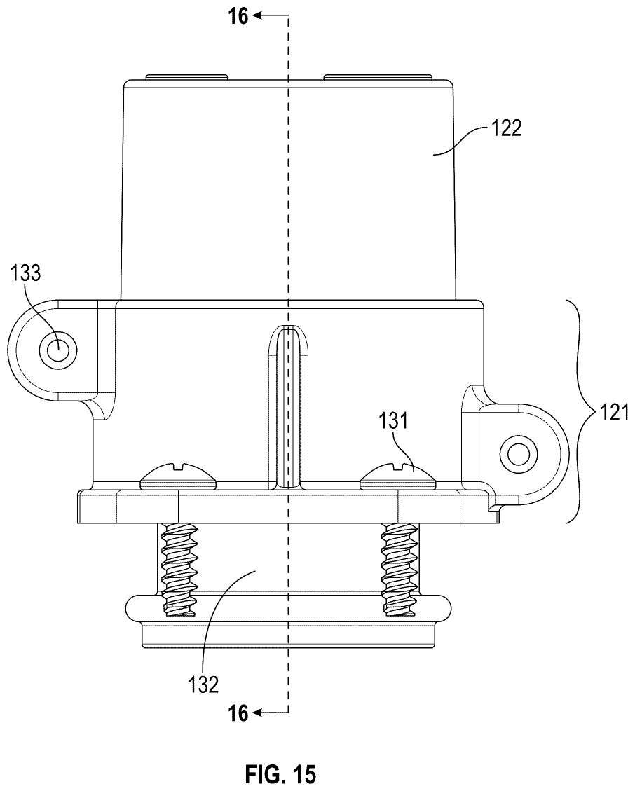

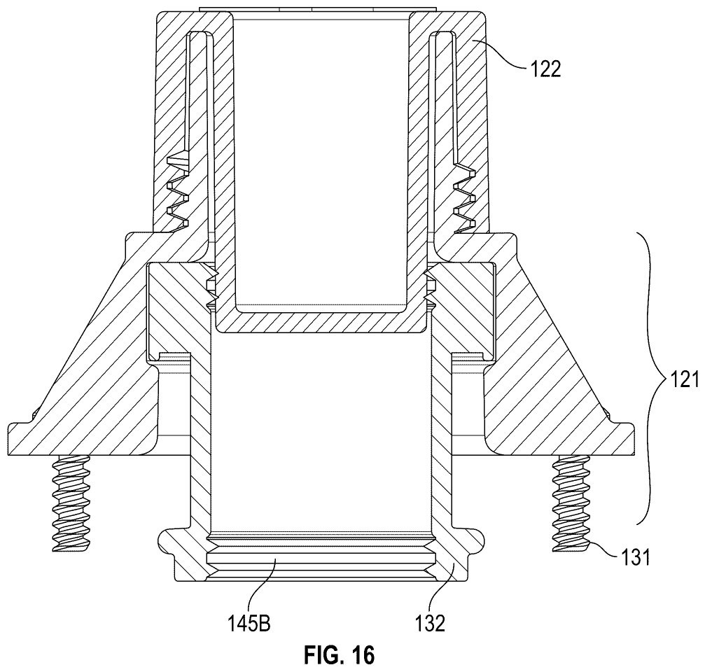

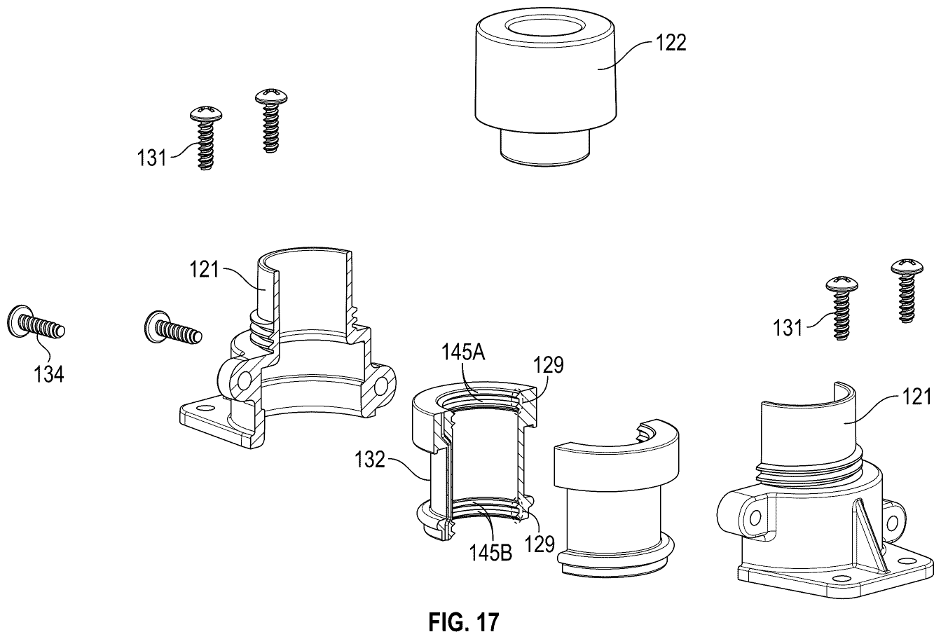

The conduit penetration housing [121], detailed in FIGS. 14-17, is joined, in one embodiment, to the bottom casing [102] of the instrument enclosure by mounting screws [131]. The conduit penetration housing [121] is provided in two pieces and is fitted to house a sealing channel [132]. Housing apertures [133] are present on the conduit penetration housing [121] to secure the sealing channel [132] via assembly screws [134], shown in FIG. 17. FIG. 16 specifically provides a cross-sectional view of the conduit penetration housing [121] with conduit penetration housing cap [122] and sealing channel [132], while FIG. 17 provides an exploded view of the aforementioned components, showing the sealing channel mechanism [129]. The sealing channel mechanism [129] is composed of the upper channel seal wiper blades [145a] and lower channel seal wiper blades [145b] of the sealing channel [132]. When a conduit is in use, both the upper- and lower channel seal wiper blades [145a, 145b] are used. When a conduit is not installed and the conduit penetration housing [121] is capped with a conduit penetration housing cap [122], only the upper channel seal wiper blades [145a] are used.

The sealing channel mechanism [129] within the sealing channel is made up of a specified sealing material that allows for a seal around the penetrating conduits or tubing. All conduit sealing mechanisms [129] are 0.188 (inches or mm) diameter and only utilize straight seal pieces for the upper- and lower channel seal wiper blades [145a, 145b]. The top and bottom seals [145a, 145b] are 0.25″×0.25″ square ethylene propylene diene monomer (EPDM) foam with adhesive or an appropriate alternative.

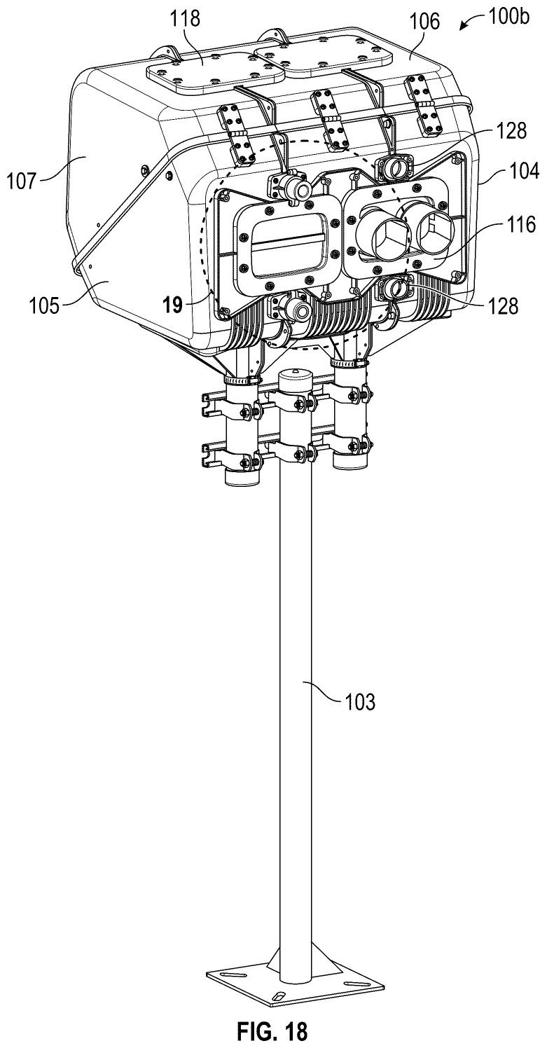

FIG. 18 illustrates a rear perspective view of the double instrument configuration [100b] of a modular multi-configurable instrument enclosure [100] having a horizontal arrangement in a closed position. In this arrangement, the tube bundle bracket [116] and the panel plug [118] are utilized. The rear of the enclosure [100b] depicts a horizontal arrangement as the conduit penetration housings [121] are in a separated positioning and are not juxtaposed as in a vertical arrangement.

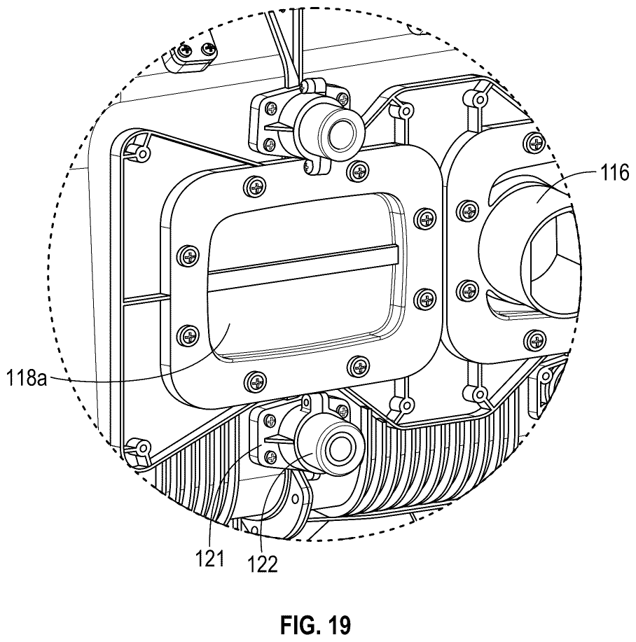

FIG. 19 illustrates a close-up view of the interchangeable window bracket for a modular multi-configurable instrument enclosure. There is a cap [118a] over the widow bracket. When a pre-set cut out is made for the window where there is no need for a bundle bracket or a post bracket, instead it is capped.

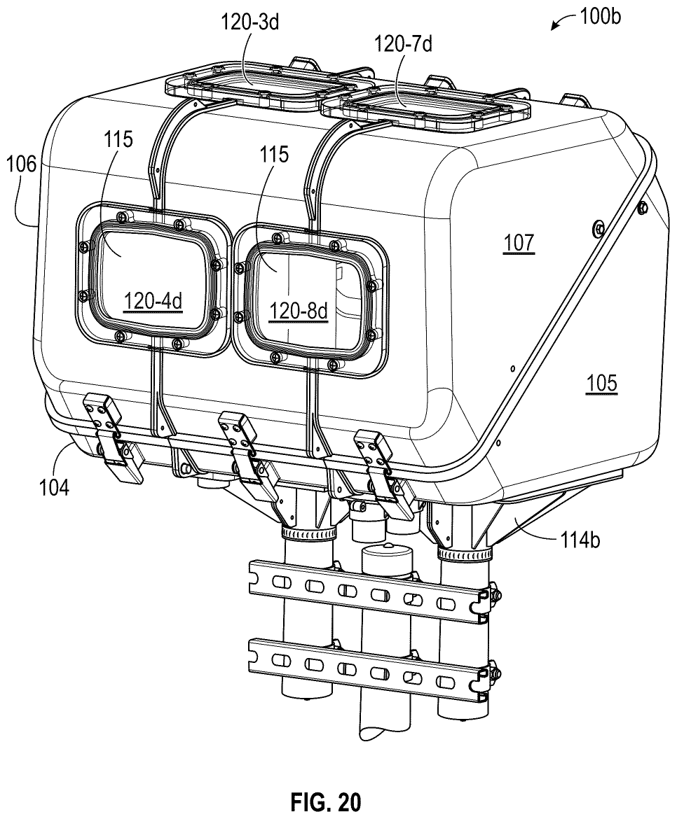

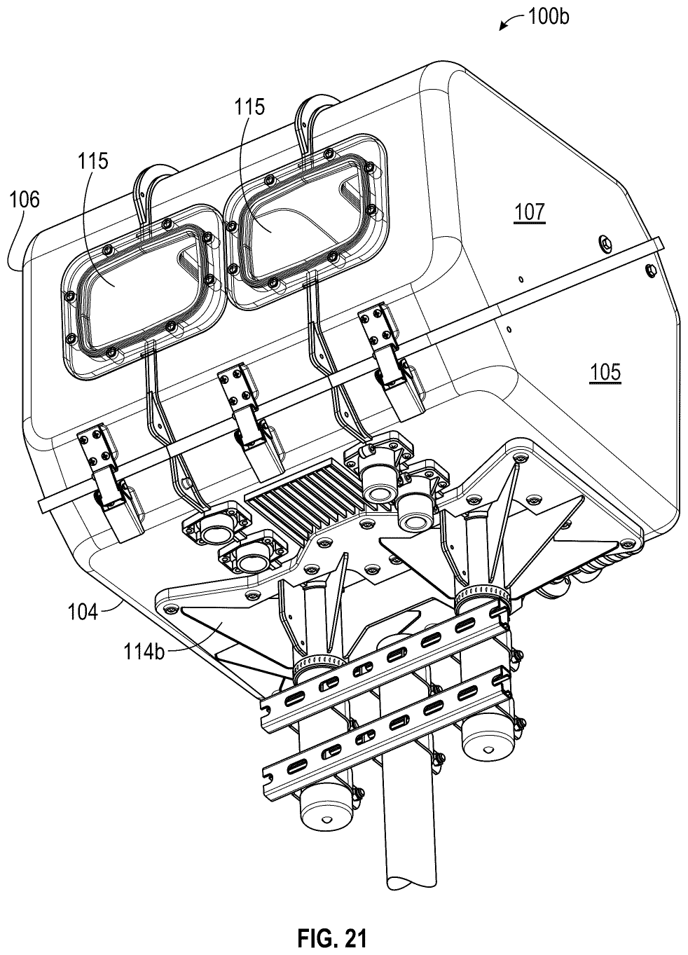

FIG. 20 illustrates a front perspective view of the double instrument configuration [100b] of a modular multi-configurable instrument enclosure [100 ] having a horizontal arrangement in a closed position. FIG. 21 illustrates a front bottom perspective view of the double instrument configuration illustrating the pipe bracket [114b]. In this configuration, the double-instrument enclosure [100b] utilizes two front facing windows [115] and two top facing windows [151] to fill component ports [120-3d, 120-4d and 120-7d, 120-8d]. These can also function as panel caps [118a] or panel plugs [118].

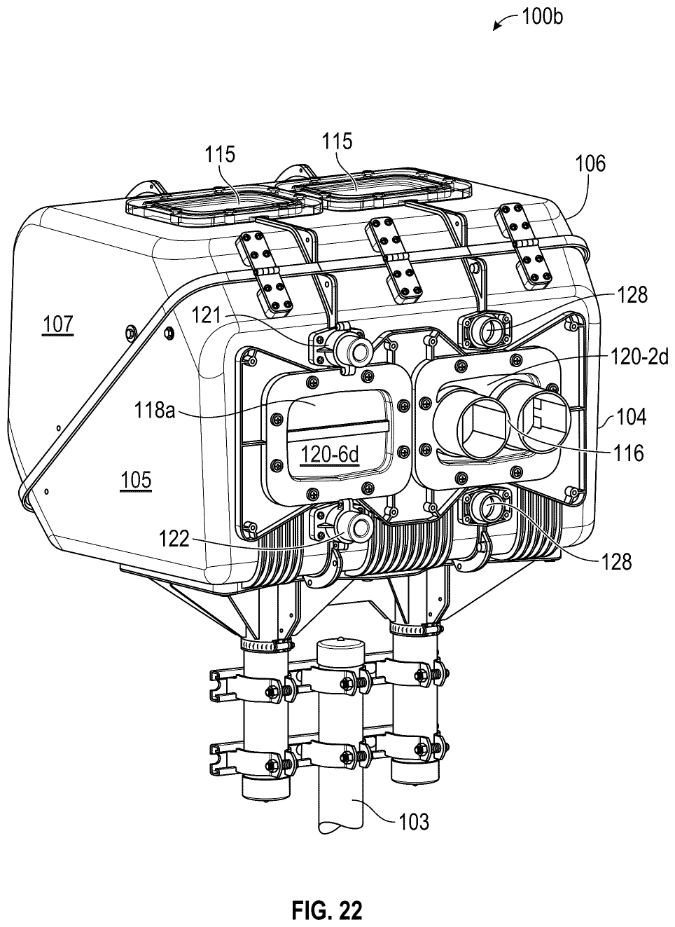

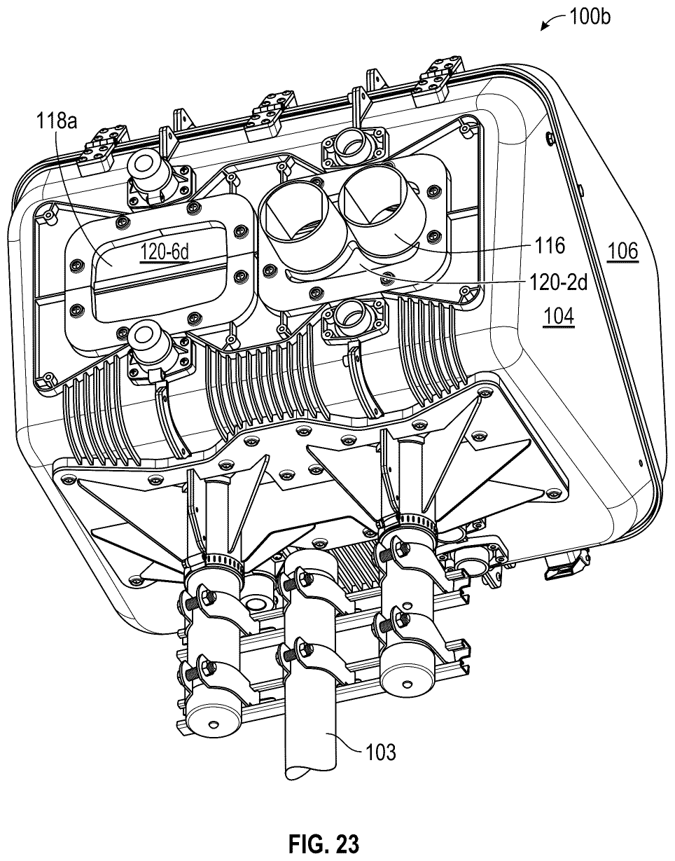

FIG. 22 illustrates a rear perspective view of the double instrument configuration [100b] of a modular multi-configurable instrument enclosure [100] having a horizontal arrangement in a closed position, and FIG. 23 illustrates a rear bottom perspective view of the double instrument configuration. In this configuration, the double-instrument enclosure [100b] utilizes a tube bundle bracket [116] and a panel cap [118a] to fill component ports [120-2d and 120-6d]. More specifically, FIG. 23 shows the bottom and back view of the double-instrument enclosure [100b]. The back view shows a tube bundle bracket [116] on the right side component port [120-2], the conduit penetration housing [121] orifices above and below the bundle bracket [116] are open (no conduit penetration housing cap [122] used) while the left side of the enclosure has a cap [118a] on the adjacent component port [120-6], and conduit brackets, with caps shown, above and below the capped bundle orifice (hole).

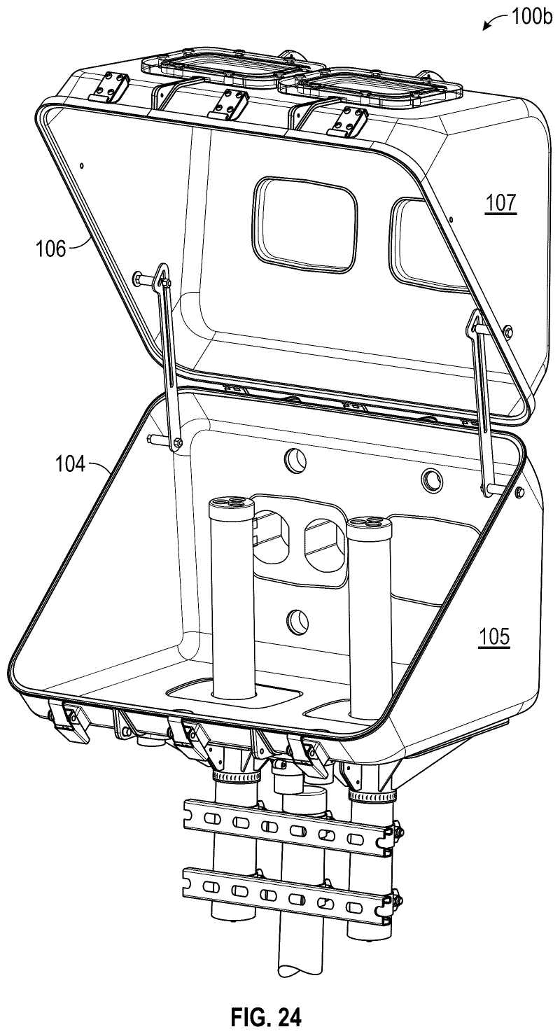

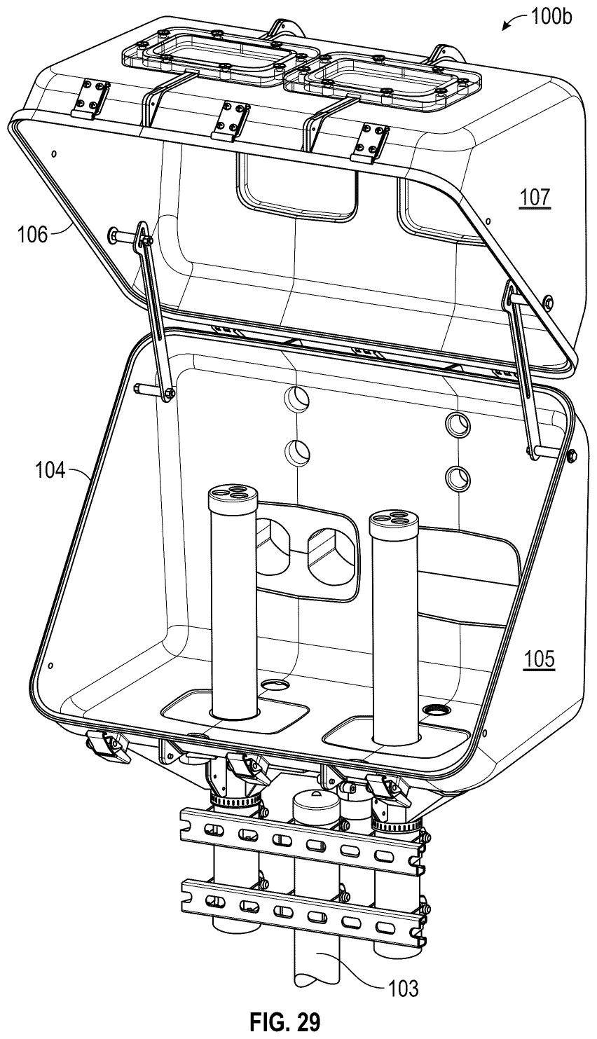

FIG. 24 illustrates a perspective view of a horizontally arranged double-instrument configuration [100b] of the modular multi-configurable instrument enclosure [100] in an open configuration prior to the inclusion of field instrumentation [110]. FIG. 29 illustrates a perspective view of a vertically arranged double-instrument configuration [100b] in an open configuration prior to the inclusion of field instrumentation [110].

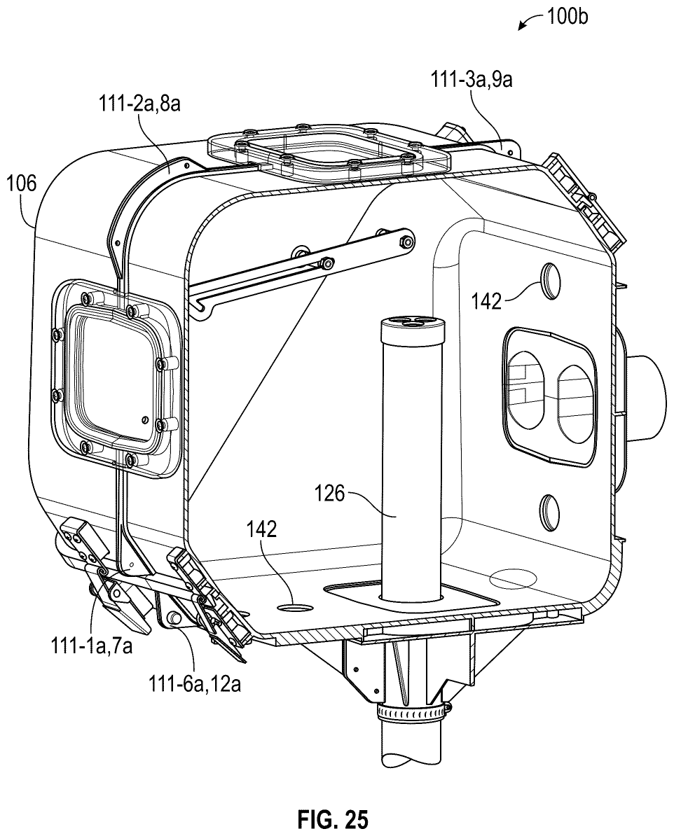

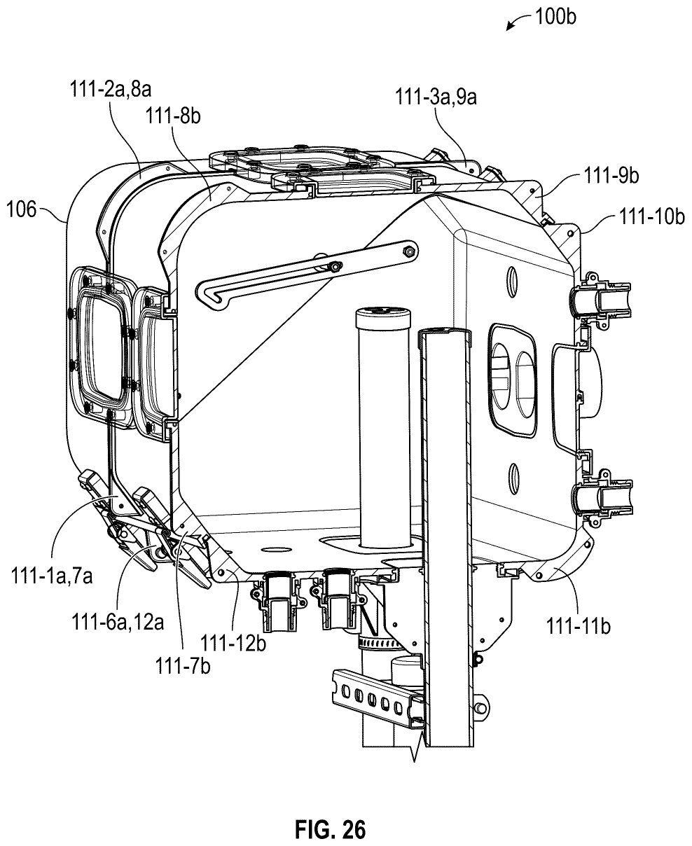

FIGS. 25 and 26 illustrate a cross-sectional view of the double-instrument enclosure [100b] Having a horizontal arrangement. In FIG. 25 the cross-section is taken in the center of the enclosure [100] showing the instrument-supportive pipe stand [126] secured in place by the double post mount bracket [114b] prior to the addition of field instrumentation [110]. The aligned apertures [111-1a,7a, 111-2a,8a, 111-3a,9a] of the top casing [101b] and aligned aperture [111-6a,12a] of the bottom casing [102b] are shown in further detail in FIG. 25. The aligned apertures [111-1a,7a, 111-2a,8a, 111-3a,9a; 111-7b, 111-8b, 111-9b] of the top casing [101b] and aligned apertures [111-6a,12a, 111-10b, 111-11b, 111-12b] of the bottom casing [102b] are shown in further detail in FIG. 26.

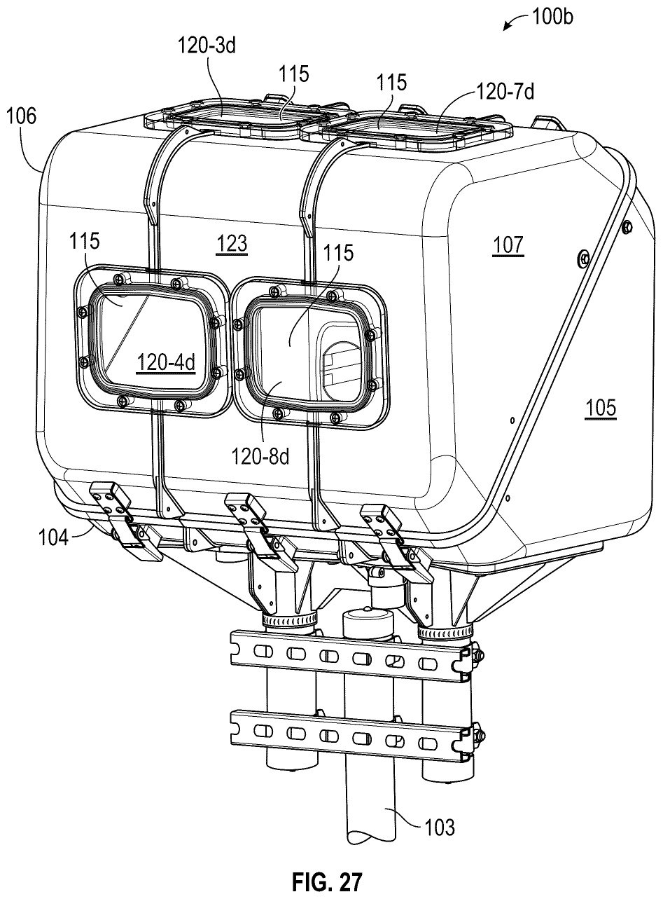

FIG. 27 illustrates a front perspective view of the double instrument configuration [100b] of a modular multi-configurable instrument enclosure [100] having a vertical arrangement in a closed position In this configuration, the double-instrument enclosure [100b] utilizes two front facing windows [115] and two top facing windows [115] to fill component ports [120-3d, 120-4d and 120-7d, 120-8d]. Here only one set of windows will be on any side, the other side would be capped with a cap [118a] or plug [118]

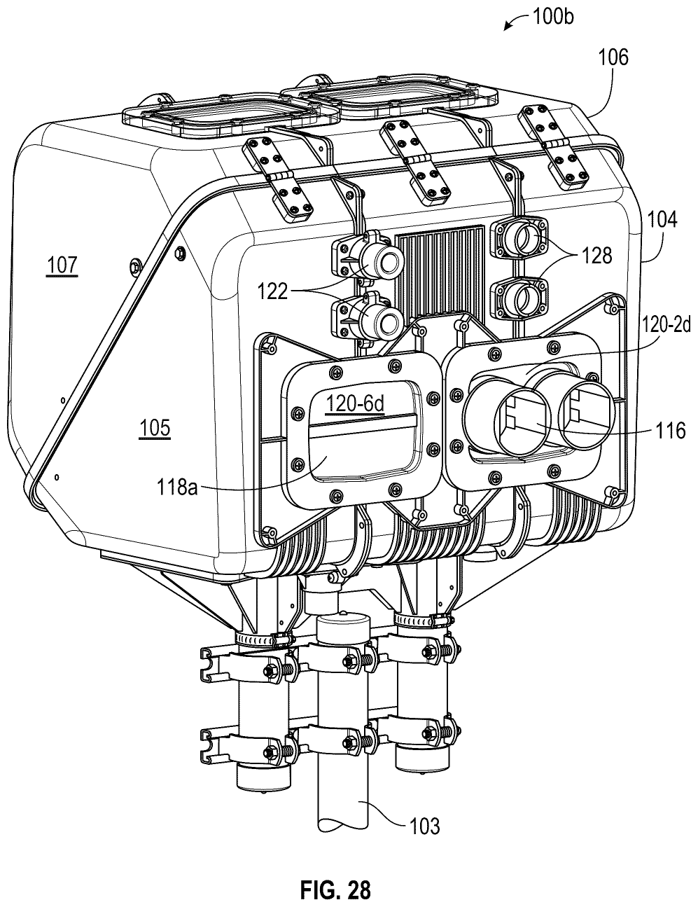

FIG. 28 illustrates a rear perspective view of the double instrument configuration [100b] of a modular multi-configurable instrument enclosure [100] having a vertical arrangement in a closed position, In this configuration, the double-instrument enclosure [100b] utilizes a tube bundle bracket [116] and a panel plug [118] to fill component ports [120-2d and 120-6d]. Here one bundle bracket and the other bundle orifice (hole) is capped. The capped bundle component port [120-6d] has two conduit penetration housings [121] that are capped with conduit penetration housing caps [122] as shown, while the other side that has the tubing bundle bracket [116] provides two openings where the pre-set embosses [128] are shown.

FIG. 29 illustrates a perspective view of a vertically arranged double-instrument configuration [100b] of the modular multi-configurable instrument enclosure [100] in an open configuration prior to the inclusion of field instrumentation [110].

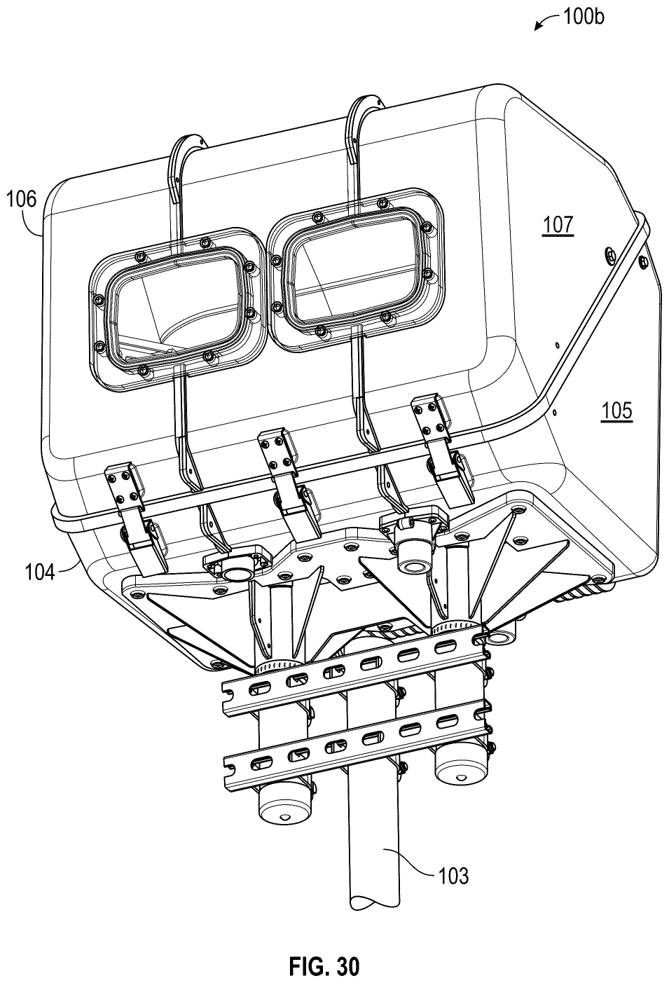

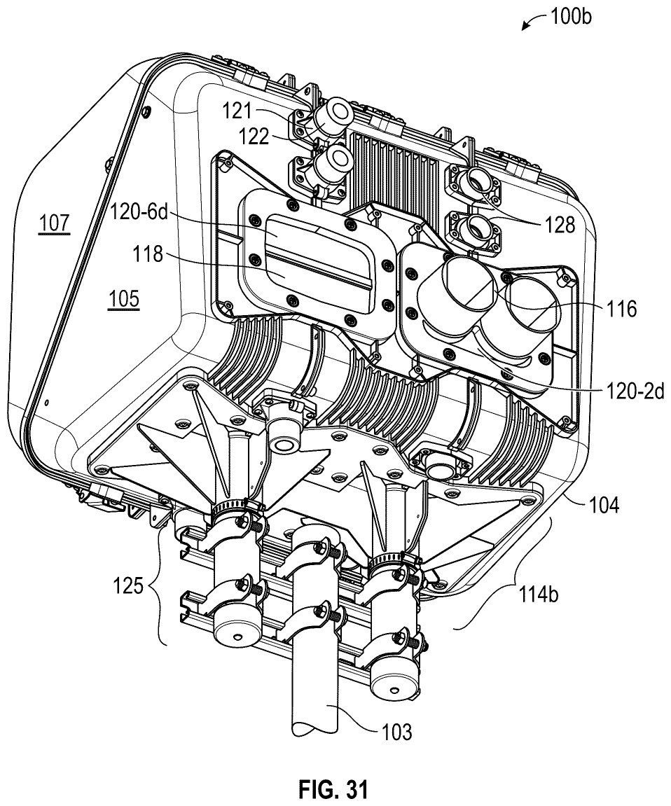

FIG. 30 illustrates a front perspective view of the double instrument configuration [100b] of a modular multi-configurable instrument enclosure [100] having a vertical arrangement in a closed position, and FIG. 31 illustrates a rear bottom perspective view of the double instrument configuration [100b]. In this configuration, the double-instrument enclosure [100b] utilizes a tube bundle bracket [116] and a panel plug to fill component ports [120-2d and 120-6d]. The bottom view of the enclosure [100] illustrates the double post mount bracket [114b] securely attached to the enclosure mounting system [125], the rear view shows a tubing bundle bracket [116] mounted within component port [120-2d], with pre-set embosses [128] above. Component port [120-6d] shows a capped [118a] bundle cut out, with conduit penetration housings [121] sealed with conduit penetration housing [122] caps above. This embodiment is for a vertical application in that the two conduit penetration housings [121] are juxtaposed (side by side, not opposite sides of the larger bracket cut out). The two pre-set embosses [128] are also juxtaposed in this configuration.

The triple-instrument configuration [100c], as depicted in FIG. 32, is constructed using a 1-2-2-3 arrangement for the top and bottom casings [101c, 102c], where the first component is a right wing component [bottom 104, top 106], termed ‘1’, the second and third components are center components [bottom 124, top 123], termed ‘2’, and the fourth component is a left wing component [bottom 105, top 107], termed ‘3’, providing LEFT (1) [104, 106]-CENTER (2) [123,124]-CENTER (2) [123,124]-RIGHT (3) [105, 107] or the 1-2-2-3 arrangement (1-2-2-3).

The top casing [101c] is assembled, in a horizontal arrangement, using the top right wing [106], two top center components [123], and the top left wing [107] each section having a top portion of a latching mechanism [108], and the bottom casing [102c] is assembled using the bottom right wing [104], two bottom center components [124], and the bottom left wing [105] each section having a bottom portion of a latching mechanism [109]. The left wings [105, 107] and the left edge of the center components [123,124] are joined by aligned apertures [111-1b,7b, 111-2b,8b, 111-3b,9b, 111-4b,10b,5b, and 111-6b,12b] using suitable fasteners, such as nuts and bolts (not shown).

The right wings [104,106], the center components are joined by aligned apertures [111-1a,7a, 111-2a,4a, 111-3a,9a, 111-11a,11b, and 111-6a,12a] using suitable fasteners, such as nuts and bolts (not shown).

The center components [123,124] are joined by aligned apertures [111-7b,7a, 111-86,8a, 111-9b,9a, 111-10b,10a, 111-11b,11a, and 111-12b,12a] using suitable fasteners, such as nuts and bolts (not shown). The triple-instrument configuration [100c] of the modular multi-configurable instrument enclosure [100] is affixed to an enclosure-supportive pipe stand [103] or other suitable standing structure via an enclosure mounting system [125]. The enclosure-supportive pipe stand [103] has fixed pipe stand supports [112] and is secured to a mounting plate [113] that can be secured to a floor, wall, ceiling, or other planar, stable surface.

A field instrument [110] can be directly mounted, affixed, or otherwise attached to the instrument-supportive pipe stand [126] or other suitable standing structure that limits contact of the field instrument [110] with the instrument enclosure [100]. In the triple-instrument configuration [100b], the enclosure-supportive pipe stand [103] acts as an instrument-supportive pipe stand for the central field instrument and enters the instrument enclosure [100] by utilizing a central conduit formed within the post mount bracket [114c].

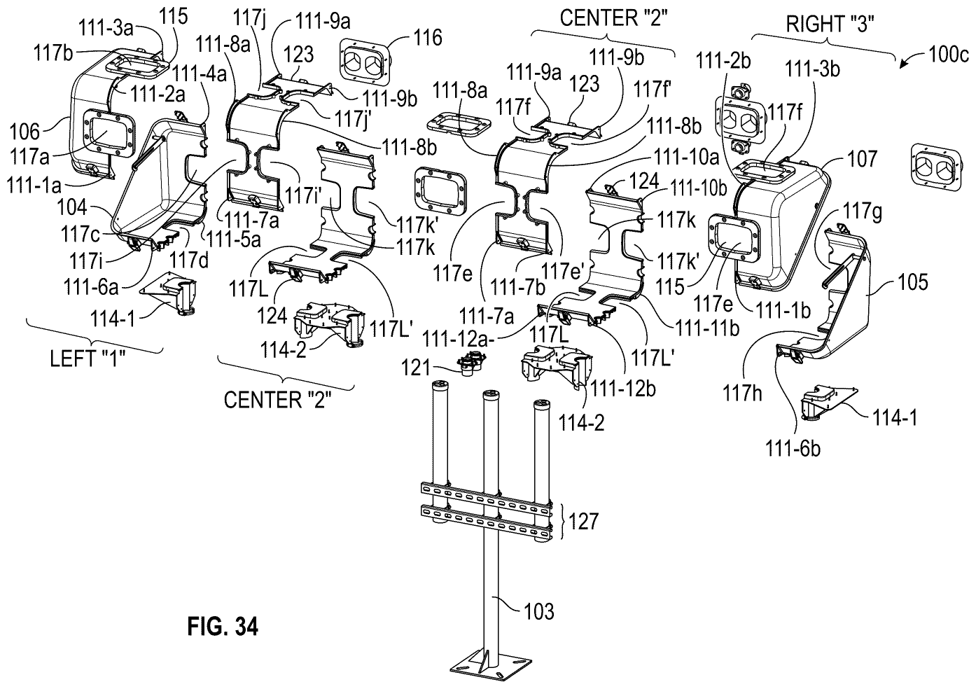

FIG. 33 and FIG. 34. provide partially exploded views of a triple-instrument configuration [101c] of the modular multi-configurable instrument enclosure [100]. The left and right wings [104, 105, 106, 107] and top and bottom center components [123,124] are mirrored in design, with the top wings [106, 107] and top center components [123] having surfaces containing arched recesses [117] to receive the interchangeable post mount bracket [114], window [115], tube bundle bracket [116], plug panel [118], and associated gaskets [119]. Once the casings [101c,102c] are attached using the aligned apertures [111-1a,7a, 111-2a,8a, 111-3a,9a; 111-4a, 10a, 111-5a,11a, 111-6a, 12a joining the RIGHT and CENTER components, 111-7b,7a, 111-8b,8a, 111-9b,9a; 111-10b,10a, 111-11b,11a, 111-12b, 12a joining the CENTER and CENTER components, while 111-7b,12a, 111-8b,2b, 111-9b,3b, 111-10b,4b, 111-11b,5b, 111-12b,6b joining the LEFT and CENTER components], the arched recesses [117] form component ports [120] and the interchangeable components [114,115,116,118] become hermetically sealed within the component ports [120-1t, 120-2t, 120-3t, 120-4t, 120-5t, 120-6t, 120-7t, 120-8t, 120-9t, 120-10t, 120-11t, 120-12t for a triple-instrument configuration] using gaskets [119], creating a controlled interior environment for field instrumentation [110].

Component port [120-1t] is formed from the alignment of arched recesses [117a] and [117i]; component port [120-2t] is formed from the alignment of arched recesses [117b] and [117j], component port [120-3t] is formed from the alignment of arched recesses [117c] and [117k]; component port [120-4t] is formed from the alignment of arched recesses [117d] and [117l]; component port [120-5t] is formed from the alignment of arched recesses [117j′] and [117i]; component port [120-6t] is formed from the alignment of arched recesses [117j′] and [117j]; component port [120-7t] is formed from the alignment of arched recesses [117k′] and [117k]; component port [120-8t] is formed from the alignment of arched recesses [117l′] and [117l]; component port [120-9t] is formed from the alignment of arched recesses [117j′] and [117e]; component port [120-10t] is formed from the alignment of arched recesses [117j′] and [117f]; component port [120-11t] is formed from the alignment of arched recesses [117k′] and [117g]; component port [120-12t] is formed from the alignment of arched recesses [117l′] and [117h].

The addition of the top and bottom center components [123,124] to the top and bottom casings [101c, 102c] continues the need for an enclosure mounting system [125] that can support a multi-instrument enclosure. The post mount bracket [114] for the triple-instrument enclosure [100c] is provided in four parts [two 114-1 and two 114-2], which when assembled provide a triple post mount bracket [114c]. The triple post mount bracket [114c] contains apertures for three instrument-supportive pipe stands [126], one of which is an extended enclosure-supportive pipe stand [103] acting as an instrument-supportive pipe stand [126], which are fastened to the enclosure-supportive pipe stand [103] by mounting brackets [127]. The mounting brackets [127] that compress against the pipe stands [103, 126] and supports the instrument enclosure [100] above it. The enclosure mounting system [125] requires that the instrument-supportive pipe stands [103, 126] that enter into the enclosure [100], be slightly maneuverable to allow for the pipe stands [103, 126] to be positioned in the pre-set post mount bracket and enclosure holes.

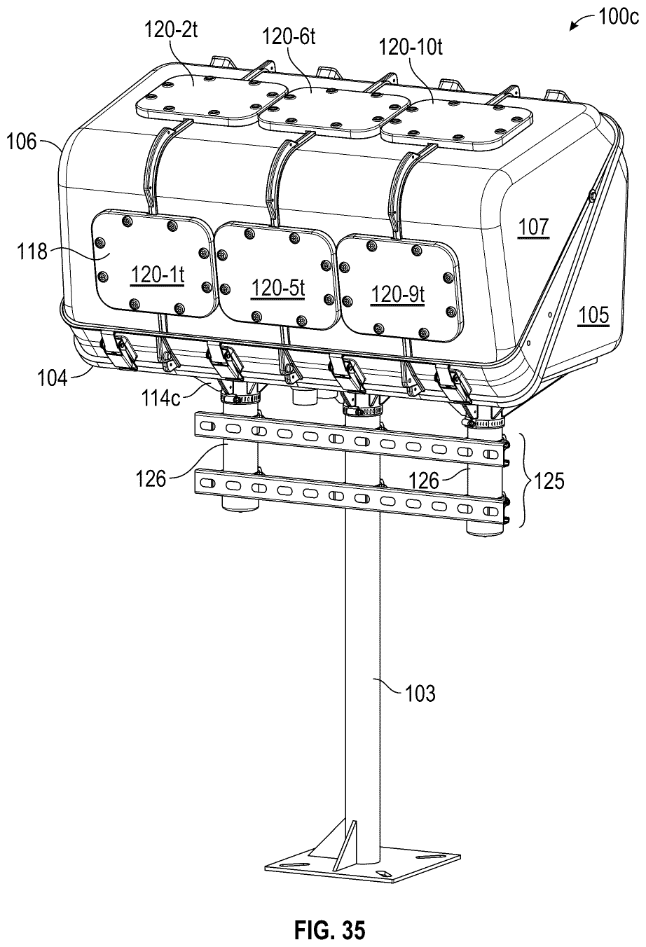

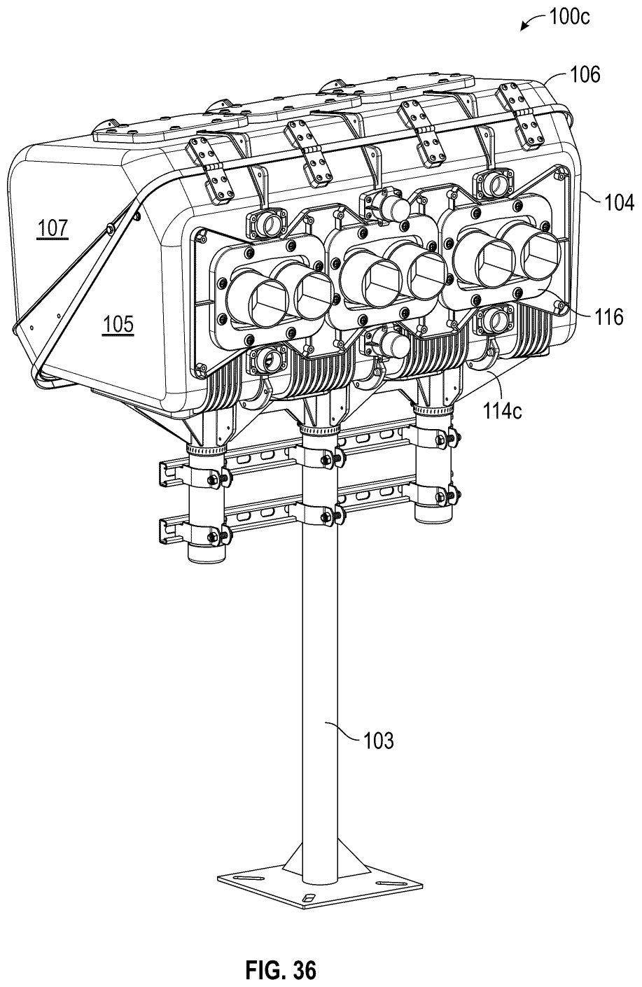

FIG. 35 illustrates a front perspective view of the triple-instrument configuration [100c] of a modular multi-configurable instrument enclosure [100] having a vertical arrangement in a closed position, and FIG. 36 illustrates a rear bottom perspective view of the triple-instrument configuration [100c]. In this configuration, the triple-instrument enclosure [100c] utilizes three tube bundle brackets [116] in rear component ports [120-3t, 120-7t, 120-11t] and panel plugs [118] (or panel caps [118a]) to fill component ports [120-1t, 120-2t, 120-5t, 120-6t, 120-9t and 120-10t]. These component panels can be equipped with any such suitable components, such as windows [115], having lenses, where the lenses can be made of any suitable material or combination of materials that allows for optimal function and data collection of the field instrument(s) [110] within the instrument enclosure [100]. For this embodiment, FIG. 36 shows three sets of tubing bundle brackets [116] with conduit orifices (holes) and new conduit brackets located above and below the tubing bundle brackets. The conduit brackets have caps (or plugs).

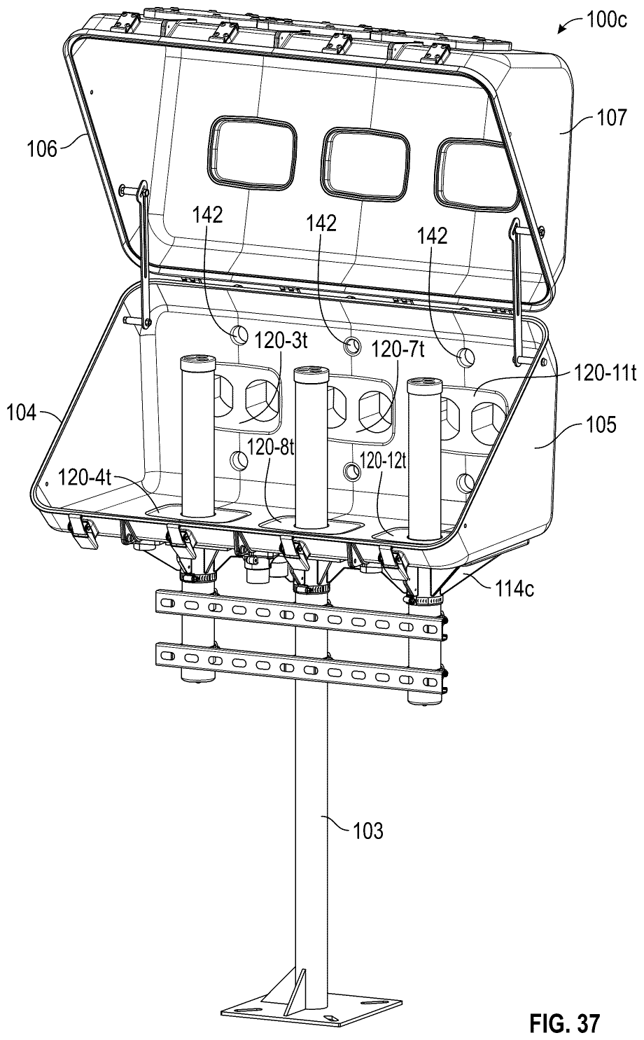

FIG. 37 illustrates a perspective view of a horizontally arranged triple-instrument configuration [100c] of the modular multi-configurable instrument enclosure in an open configuration prior to the inclusion of field instrumentation [110].

As best illustrated in FIGS. 2, 9, and 32, the modular multi-configurable instrument enclosure [100] is in an open position, with a top section casing [101] that includes first, second, third, and fourth edges [101-1, 101-2, 101-3, and 101-4]. Similarly, a bottom section casing [102] includes first, second, third, and fourth edges [102-1, 102-2, 102-3, and 102-4]. The first edge [102-1] of the bottom casing [102] may be hinged or otherwise rotatably-affixed to the first edge [101-1] of the top casing [101] via one or more hinges [141] or other suitable attachments, in which second, third, and fourth edges [101-2, 101-3, and 101-4], of top casing [101] are in contact with or in close proximity to second, third, and fourth edges [102-2, 102-3 and 102-4] of the bottom casing [102].

Although the figures illustrate hinging between the top casing [101] sections and the bottom casing [102] sections along first edges [101-1, 102-1] of the top casing [101] sections and the bottom casing [102] sections, embodiments of the modular multi-configurable instrument enclosure [100] may include additional hinging between top casing [101] and bottom casing [102] sections to provide variations of open and closed configurations of modular multi-configurable instrument enclosures in addition to the open and closed configurations supported by the illustrated hinging. Such additional hinging may include, without limitation, fixed or detachable hinging between second edges [101-2, 102-2], fixed or detachable hinging between third edges [101-3, 102-3], and fixed or detachable hinging between fourth edges [101-4, 102-4].

In the closed position, the top casing [101] and bottom casing [102] cooperatively define a hexahedral instrument enclosure space within which a field instrument [110] may be located. In at least some embodiments, top casing [101] and bottom casing [102] sections cooperatively form a cubic or substantially cubic modular multi-configurable instrument enclosure [100]. In at least some other embodiments, the top casing [101] and bottom casing [102] sections cooperatively form a rectangular cuboid or substantially rectangular cuboid instrument enclosure [100].

The left, center and right bottom casing components [104, 124, 105] illustrated further include or define notches [142], configured to engage conduit penetration housing [121], tubing (not shown), and provide for enclosing power wires (not shown), and notches [142] configured to engage tubing (not shown) that also encloses communication wires or fibers (not shown). While the notches [142] are illustrated as smooth and continuous arcs, embodiments may incorporate grooves and/or other elements to better restrict or engage the applicable pipes, tubing, or other structural elements.

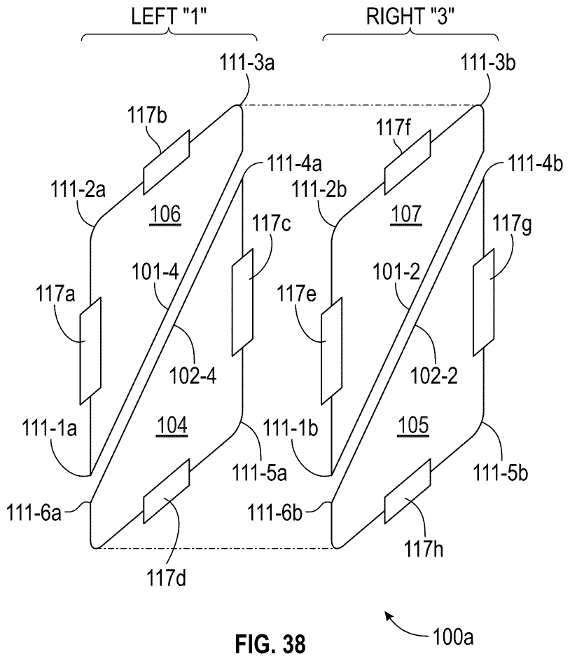

FIG. 38 schematically illustrates the attachment aperture and interchangeable port positioning of the multi-configurable single-instrument enclosure as described throughout.

The single configuration [100a], as depicted in FIG. 2, is completed using a 1-3 arrangement using right wing components [bottom 104, top 106], termed ‘1’, and left wing components [bottom 105, top 107], termed ‘3’, providing LEFT ‘1’ [104, 106]-RIGHT ‘3’ [105, 107] or the 1-3 arrangement (1-3).

Construction of the instrument enclosure in a single configuration [100a] is completed by attaching aligned aperture [111-2a] to aligned aperture [111-2b], which when connected is notated as aligned aperture [111-2a,b], and the remaining attachments of aligned apertures [111-3a,b, 111-4a,b, 111-5a,b, 111-6a,b, and 111-1a,b]. Component ports [120-1, 120-2, 120-3, 120-4], as shown in FIG. 5, are formed from the alignment of arched recesses. Component port [120-1] is formed from the alignment of arched recesses [117a] and [117e], component port [120-2] from arched recesses [117c] and [117g], component port [120-3] from arched recesses [117b] and [117f], component port [120-4] from arched recesses [117d] and [117h].

The second edges [101-2, 102-2] and fourth edges [101-4, 102-4] are shown, where the second, and fourth edges [101-2, 101-4] of the top casing are in contact with or in close proximity to the second, and fourth edges [102-2, 102-4] of the bottom casing [102].

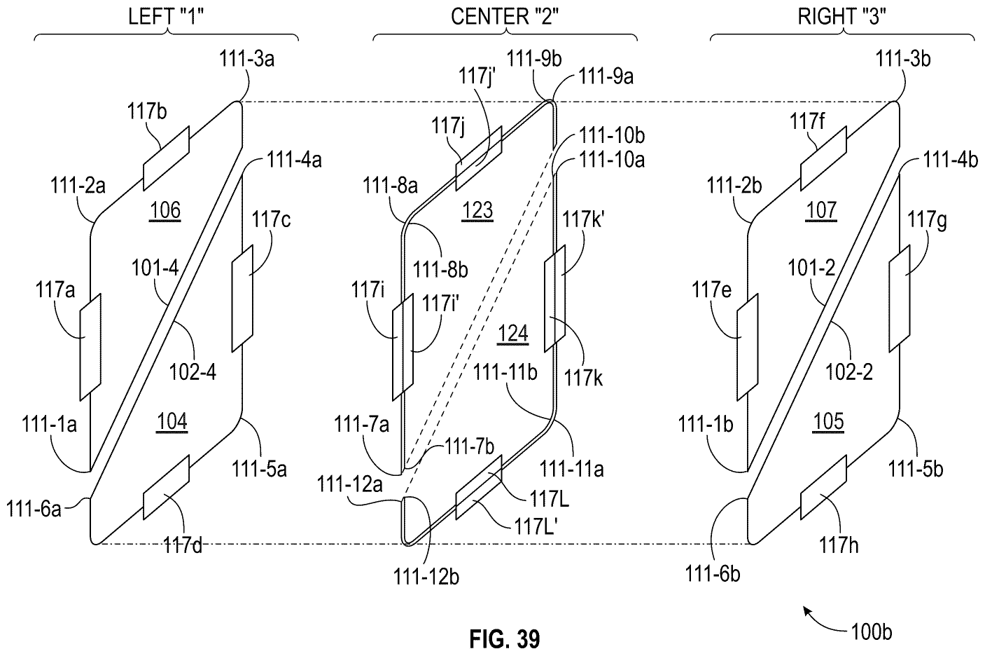

FIG. 39 schematically illustrates the attachment aperture and interchangeable port positioning of the multi-configurable double-instrument enclosure as described throughout.

The double-instrument configuration [100b], as depicted in FIG. 9, is constructed using a 1-2-3 arrangement using the right wing component [bottom 104, top 106], termed ‘1’, a center component [bottom 124, top 123], termed ‘2’, and a left wing component [bottom 105, top 107], termed ‘3’, providing LEFT (1) [104, 106]-CENTER (2) [123,124]-RIGHT (3) [105, 107] or the 1-2-3 arrangement (1-2-3).

Construction of the instrument enclosure in a double configuration [100b] is completed by attaching aligned aperture [111-1a,7a, 111-2a,8a, 111-3a,9a; 111-4a,10a, 111-5a, 11a, 111-6a, 12a joining the RIGHT and CENTER components, 111-76,7a, 111-8b,8a, 111-9b,9a; 111-10b,10a, 111-11b,11a, 111-12b,12a joining the CENTER and CENTER components, while 111-7b,12a, 111-8b,2b, 111-9b,3b, 111-10b,4b, 111-11b,5b, 111-12b,6b joining the LEFT and CENTER components. Component ports [120-1d to 120-8d], as shown in FIG. 11, are formed from the alignment of arched recesses. Component port [120-1d] is formed from the alignment of arched recesses [117a] and [117i], component port [120-2d] from arched recesses [117b] and [117j′], component port [120-3d] from arched recesses [117c] and [117k], component port [120-4d] from arched recesses [117d] and [117l], component port [120-5d] from arched recesses [117i′] and [117e], component port [120-6d] from arched recesses [117j′] and [117f], component port [120-7d] from arched recesses [117k′] and [117g], component port [120-8d] from arched recesses [117l′] and [117h].

The second edges [101-2, 102-2] and fourth edges [101-4, 102-4] are shown, where the second, and fourth edges [101-2, 101-4] of the top casing [101] are in contact with or in close proximity to the second, and fourth edges [102-2, 102-4] of the bottom casing [102].

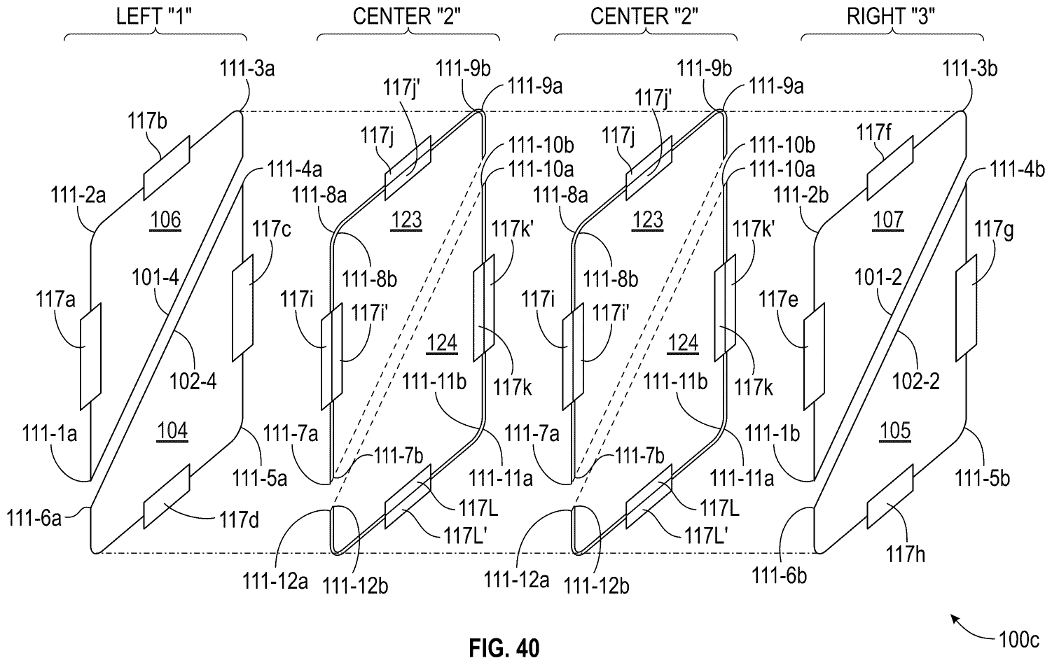

FIG. 40 schematically illustrates the attachment aperture and interchangeable port positioning of the multi-configurable triple-instrument enclosure as described throughout.

The triple-instrument configuration [100c], as depicted in FIG. 32, is constructed using a 1-2-2-3arrangement using the right wing component [bottom 104, top 106], termed ‘1’, center components [bottom 124, top 123], termed ‘2’, and a left wing component [bottom 105, top 107], termed ‘3’, providing LEFT (1) [104, 106]-CENTER (2) [123,124]-CENTER (2) [123,124]-RIGHT (3) [105, 107] or the 1-2-2-3 arrangement (1-2-2-3).

Construction of the instrument enclosure in a triple configuration [100c] is completed by attaching aligned apertures [111-1a,7a, 111-2a,8a, 111-3a,9a; 111-4a, 10a, 111-5a, 11a, 111-6a, 12a joining the RIGHT and CENTER components, 111-76,7a, 111-8b,8a, 111-9b,9a; 111-10b, 10a, 111-11b,11a, 111-12b,12a joining the CENTER and CENTER components, while 111-7b, 12a, 111-8b,2b, 111-9b,3b, 111-10b,4b, 111-11b,5b, 111-12b,6b joining the LEFT and CENTER components]. Component port [120-1t] is formed from the alignment of arched recesses [117a] and [117i], component port [120-2t] from arched recesses [117b] and [117j], component port [120-3t] from arched recesses [117c] and [117k], component port [120-4t] from arched recesses [117d] and [117l], component port [120-5t] from arched recesses [117j′] and [117i], component port [120-6t] from arched recesses [117j′] and [117j], component port [120-7t] from arched recesses [117k′] and [117k], component port [120-8t] from arched recesses [117′l] and [117l], component port [120-9t] from arched recesses [117j′] and [117e], component port [120-10t] from arched recesses [117j′] and [117f], component port [120-11t] from arched recesses [117k′] and [117g], and component port [120-12t] from arched recesses [117l′] and [117h].

The second edges [101-2, 102-2] and fourth edges [101-4, 102-4] are shown, where the second, and fourth edges [101-2, 101-4] of the top casing [101] are in contact with or in close proximity to the second, and fourth edges [102-2, 102-4] of the bottom casing [102].

Supporting the field instrument may include one or more operations including: attaching the field instrument to the standing structure, wherein the instrument enclosure defines an aperture configured to receive a terminal portion of the standing structure and attaching the field instrument to one or more attachment features of the instrument enclosure.

I claim:

1. One or more modular expandable multi-configurational instrument enclosures, comprising: a top section casing with a first, second, third, and fourth edge and bottom section casing with a first, second, third, and fourth edge, wherein said first edge of said bottom section casing is hinged and/or rotatably-affixed to said first edge of said top section casing via one or more hinges and wherein second, third, and fourth edges of said top casing section are in contact with or in immediate proximity to said second, third, and fourth edges of said bottom section casing that provides a housing enclosure that is at least a portion of said instrument enclosures such that one or more instruments within said enclosures are rotatable and wherein one or more hinges are configured so that said top section casing and said bottom section casing rotates between a closed position and one or more opened positions such that a bottom portion of said bottom section casing comprises two or more sections that includes both a bottom outer right side winged portion and a bottom outer left side winged portion such that when a center section is added between said bottom outer left side wing portion and said bottom outer right side wing portion joins both bottom portions with or without a center section of said bottom portion is created and resides between said outer right side wing portion and said outer left side wing portion and provides at least two orifices that allow for two pipe stands to enter into an annular space of said instrument enclosures in order that instruments that reside within said instrument enclosures are also mountable to said two pipe stands and wherein said modular multi-configurable instrument enclosures include at least one conduit/tube for pre-set engineered orifices configurations such that said instrument enclosures are standardized installation enclosures that house complex multi-instruments with multi-tube requirements that also include impulse and blow down capabilities.

2. The one or more modular multi-configurational instrument enclosures of claim 1 wherein said two orifices between said center section and said left bottom winged portion and said center section and said right bottom winged portion that provides for location of a tubing bundle bracket with pre-set orifices so that tubing bundles enter into said instrument enclosures such that tubing within said tubing bundles are plumbed to said instruments upon installation that reduces pluming installation times without use of said instrument enclosures.

3. The one or more modular multi-configurational instrument enclosures of claim 1, wherein when said instrument enclosures require an expandable triple instrument enclosure, two center sections exist between an outer left winged portion and an outer right winged portion which creates three configured orifices between two center sections such that said two center sections reside between a left center portion and a left bottom winged portion and also between a right center section and a right bottom winged portion that includes three tubing bundle brackets with pre-set orifices so that three of more sets of tubing bundles can penetrate into said instrument enclosures so that tubing bundles are plumbed to said instruments upon installation.

4. The one or more modular multi-configurational instrument enclosures of claim 1, wherein hinges between said top section casing and said bottom section casing along first edges of said top section casing and said bottom section casing includes additional hinging between top casing and bottom casing sections that provides multiple variations of open and closed configurations of said instrument enclosures wherein said additional hinging includes fixed and/or detachable hinging between any of second, third and fourth edges.

5. The one or more modular multi-configurational instrument enclosures of claim 1, wherein a first part of said bottom section casing possesses a first notch; a second part of said bottom section casing possesses a second notch; and wherein said first notch and said second notch are configured to define an opening in said bottom section casing.

6. The one or more modular multi-configurational instrument enclosures of claim 1, wherein said enclosures include a support bracket that provides compression against two or three pipe stands and supports said instrument enclosures so that multiple configurable and modular units are provided for both double and triple enclosure configurations.

7. The one or more modular multi-configurational instrument enclosures of claim 1 wherein said enclosures also include pipe stand systems for vertical pipes to enter into said instrument enclosures that are maneuverable in that said pipe stand systems allow for pipes to be positioned in one or more prefabricated and mounted support brackets with openings that allow for single, double, and triple pipe stand configurations.

8. The one or more modular multi-configurational instrument enclosures of claim 1, wherein said conduit seals provide a separate housing portion attached to said enclosures via prefabricated bosses so that said bosses provide for screw and heating elements insertion while conduit seal housings are fixed to said instrument enclosures at precise locations where conduit penetration is required and wherein contained within said conduit housings are sealing mechanisms that include sealing compositions to seal penetrating conduits or tubing placed into said instrument enclosures.

9. The one or more modular multi-configurational instrument enclosures of claim 1, wherein an opening in said bottom section casing is configured to accept and connect with a pipe stand and wherein said pipe stand is attached to said bottom section casing and/or resides within an instrument enclosure.

10. The one or more modular multi-configurational instrument enclosures of claim 4, wherein: one or more interior surfaces of said bottom section casing includes one or more instrument attachment elements that allow for attachment to, removal of, and/or rotation for a field instrument to said bottom section casing; and wherein said enclosed space exists to receive one or more field instruments removably attached to said bottom section casing.

11. The one or more modular multi-configurational instrument enclosures of claim 2, wherein an opening in said bottom section casing is configured to receive one or more process line conduits that convey one or more measurable process parameters to said one or more field instruments.

12. The one or more modular multi-configurational instrument enclosures of claim 6, wherein: said one or more process line conduits are enclosed in-process line tubing; and said opening in said bottom section casing is configured to engage said process line tubing.

13. The one or more modular multi-configurational instrument enclosures of claim 1, wherein:
a first portion of said bottom section casing defines a first pipe notch and a first line notch; and a second portion of said bottom section casing defines a second pipe notch and a second line notch such that said first pipe notch and said second pipe notch are configured to define a pipe stand opening in said bottom section casing such that said pipe stand opening is configured to engage said pipe stand; and wherein said first line notch and said second line notch are configured to define a process line opening in said bottom section casing;
wherein said process line opening is configured to receive process line tubing enclosing one or more process line signals conveying one or more process line parameters to said one or more field instruments.

14. The one or more modular multi-configurational instrument enclosures of claim 1, wherein:
said bottom section casing is configured to be fastened to bracket affixed to said pipe stand;
wherein said bracket includes a plurality of openings suitable for receiving fasteners; and
wherein
said bottom section casing includes a plurality of openings corresponding to said plurality of openings in said bracket.

15. The one or more modular multi-configurational instrument enclosures of claim 1, wherein, said instrument enclosures comprise a convex polyhedral instrument enclosure.

16. The one or more modular multi-configurational instrument enclosures of claim 1, wherein said convex polyhedral instrument enclosures comprise a hexahedral instrument enclosure comprising six planar surfaces including an upper surface, a lower surface, a forward surface, a rearward surface, a left surface, and a right surface.

17. The one or more modular multi-configurational instrument enclosures of claim 1, wherein:
said top section casing includes an upper surface, a forward surface, a first portion of a left surface, and a first portion of a right surface; and said bottom section casing includes a lower surface, a rearward surface, a second portion of a left surface, and a second portion of a right surface.

18. The one or more modular multi-configurational instrument enclosures of claim 1, wherein: said first part of said bottom section casing includes a first portion of said lower surface, a first portion of said rearward surface, and said second portion of left surface; and a second part of said bottom section casing includes a second portion of said lower surface, a second portion of said rearward surface, and a second portion of said right surface.

19. The one or more modular multi-configurational instrument enclosures of claim 1, wherein said first portion of said lower surface comprises a first half portion of said lower surface; said second portion of said lower surface comprises a second half portion of said lower surface said first portion of said rearward surface comprises a first half or said rearward surface and said second portion of said rearward surface comprises a second half of said rearward surface.

20. The one or more modular multi-configurational instrument enclosures of claim 14, wherein at least one planar surface of said instrument enclosures contains one or more windows that are transparent and exhibit durability that minimize or eliminate breakage of said windows.

21. The one or more modular multi-configurational windows of claim 15, wherein said windows are composed of tempered glass.

22. A method of providing one or more one or more modular multi-configurational instrument enclosures that enclose and protect one or more field instruments at a desired location, said method comprising:
hinging a hinged section of an instrument enclosure to a vertical support section that is self-standing and/or secured to stand vertically, including a pipe stand, located in said desired location wherein said hinging enables said hinged section to rotate relative to said vertical support section between a closed position and one or more open positions of said instrument enclosures such that one or more instruments mounted within said one or more instrument enclosures are also capable of rotation or other position adjustments and wherein a combination of said vertical support section and said hinged section, in a closed position defines an enclosed space that is dimensioned to receive said one or more field instruments and wherein said one or more instrument disclosures are constructed so that a protective barrier between an enclosed space and an external environment wherein said instrument enclosures are located such that said protective barrier shields said enclosed space from one or more environmental elements;
and;
affixing said one or more field instruments to one or more supporting structures wherein said field instruments are disposed in a predetermined position within said enclosed space such that said instrument enclosure is attached to said vertical support section wherein said hinged section is hinged to said vertical support section and said instrument enclosures are enclosed within a closed portion of said instrument enclosures.

23. The method of claim 22, wherein a sequence of performing said hinging, said attaching, and said supporting includes a sequence selected from a group consisting of:
hinging, attaching, and supporting; attaching, hinging, and supporting; supporting, hinging, and attaching; and
supporting, attaching, and attaching.

24. The method of claim 22, further comprising: forming said fixed section by fastening a first part of said hinged section to a second part of said hinged section.

25. The method of claim 22, wherein supporting field instruments comprise performing an operation to provide support from a group consisting of:
attaching said field instruments to said vertical support structure, wherein said instrument enclosure defines an aperture configured to receive a terminal portion of said vertical support structure; allowing for rotation and/or other positioning of said field instruments within said instrument enclosures and attaching said field instruments to one or more attachment features of said instrument enclosure.
